(19) United States
(12) Patent Application Publication
(10) Pub. No.: US 2024/0286347 A1
(43) Pub. Date: Aug. 29, 2024

(54) Articles Formed From Fluorine-Containing Elastomer Compositions Using Additive Manufacturing Methods and Additive Manufacturing Methods for Thermoset Elastomer Compositions

(71) Applicant: Greene,Tweed Technologies, Inc., Wilmington, DE (US)

(72) Inventors: Mookkan Periyasamy, Wilmington, DE (US); Ronald R. Campbell, Lansdale, PA (US); Joey L. Mead, Boston, MA (US); David O. Kazmer, Boston, MA (US); Stiven Kodra, Boston, MA (US); A. A. Mubasshir, Boston, MA (US)

(73) Assignee: Greene,Tweed Technologies, Inc., Wilmington, DE (US)

(21) Appl. No.: 18/509,212

(22) Filed: Nov. 14, 2023

Related U.S. Application Data
(63) Continuation-in-part of application No. 17/219,249, filed on Mar. 31, 2021.
(60) Provisional application No. 63/383,666, filed on Nov. 14, 2022.
(60) Provisional application No. 63/003,149, filed on Mar. 31, 2020.

(51) Int. Cl. B29C 64/209; B29C 64/227; B29C 64/295; B29C 64/321; B29K 19/00; B29L 31/26; B33Y 30/00; B33Y 70/00; B33Y 80/00

(52) U.S. Cl. CPC B29C 64/209; B29C 64/227; B29C 64/295; B29C 64/321; B29K 2019/00; B29L 2031/265; B33Y 30/00; B33Y 70/00; B33Y 80/00

(57) ABSTRACT

An apparatus suitable for extruding curable polymers for forming elastomer articles using additive manufacturing, and curable fluorine-containing polymer compositions suitable for use in such an apparatus are disclosed along with an additive manufacturing method for forming a fluorine-containing elastomer including providing a curable fluoropolymer composition, comprising at least one curable fluoropolymer; providing an additive manufacturing printer apparatus comprising a ram material extruder, wherein the ram material extruder comprises a ram device operable for extrusion under pressure and a printer nozzle; introducing the curable fluoropolymer composition to the ram material extruder; applying heat to the ram device, including the printer nozzle thereof; and applying pressure to the ram device to extrude the curable fluoropolymer composition; and printing, using the additive manufacturing printer apparatus, at least one layer of the extruded curable fluoropolymer composition exiting from an outlet of the printer nozzle onto a substrate to form the fluorine-containing elastomer article.

### CROSS-REFERENCE TO RELATED APPLICATIONS

This U.S. non-provisional patent application claims the benefit, under 35 U.S.C. § 119(e), of U.S. Provisional Patent Application No. 63/383,666, filed Nov. 14, 2022, entitled, “Articles Formed from Fluorine-Containing Elastomer Compositions Using An Additive Manufacturing Method and Additive Manufacturing Methods for Thermoset Elastomer Compositions”; and this U.S. non-provisional patent application also claims priority under 35 U.S.C. § 120 as a continuation-in-part, non-provisional patent application of U.S. Patent Application No. 17/219,249, filed Mar. 31, 2021, entitled, “Articles Formed From Fluorine-Containing Elastomer Compositions Using an Additive Manufacturing Method and Additive Manufacturing Methods for Thermoset Elastomer Compositions,” which claims the benefit under 35 U.S.C. § 119(e), of U.S. Provisional Patent Application No. 63/003,149, filed Mar. 31. 2020, entitled, “Articles Formed From Fluorine-Containing Elastomer Compositions Using an Additive Manufacturing Method and Additive Manufacturing Methods for Thermoset Elastomer Compositions,” wherein the entire disclosures of each of the above-referenced applications are incorporated herein by reference.

### BACKGROUND OF THE INVENTION

### Field of The Invention

The invention relates the field of additive manufacturing, particularly additive manufacturing of thermoset elastomers, including fluorine-containing elastomers, through fused filament fabrication and deposition.

### Description of Related Art

Additive manufacturing, also commonly referred to as three-dimensional (“3D”) printing is increasing in popularity for rapid prototyping and commercial production of articles. Various types of additive manufacturing processes are known, including vat photopolymerization methods such as stereolithography (“SLA”), material or binder jetting methods, powder bed fusion methods such as selective laser sintering (“SLS”), and material extrusion methods such as fused deposition modeling (“FDM”), fused-filament fabrication (“FFF”) and direct pellet extrusion, among others.

In vat photopolymerization methods, a liquid photopolymer resin is stored in a vat in which a build platform is positioned. An article can be formed based on a computer model of the article in which the article is represented as a series of layers or cross sections. Based on the computer model, a first layer of the article is formed using UV light to selectively cure the liquid photopolymer resin. Once the first layer is formed, the build platform is lowered, and the UV light is used to cure the liquid photopolymer resin so as to form a subsequent layer of the article on top of the first layer. This process is repeated until the printed article is formed.

In material jetting methods, an article is prepared in a layer-by-layer manner by depositing drops of a liquid material, such as a thermoset photopolymer, to form a first layer of the article based on a computer model of the article. The deposited layer of liquid material is cured or solidified, such as by the application of UV light. Subsequent layers are deposited in the same manner so as to produce a printed article. In binder jetting, an article is formed by depositing a layer of a powdered material on a build platform and selectively depositing a liquid binder to join the powder. Subsequent layers of powder and binder are deposited in the same manner and the binder serves as an adhesive between powder layers.

In powder bed fusion methods, and specifically SLS, an article is formed by generating a computer model of the article to be printed in which the article is represented as a series of layers or cross-sections. To prepare the article, a layer of powder is deposited on a build platform and the powder is sintered by the use of a laser to form a layer of the article based on the computer model. Once the layer is sintered, a further layer of powder is deposited and sintered. This process is repeated as necessary to form the article having the desired configuration.

In material extrusion methods, such as FDM or FFF, a computer model of an article is generated in which the article is represented as a series of layers. The article is produced by feeding a filament of material to an extruding head which heats the filament and deposits the heated filament on a substrate to form a layer of the article. Once a layer is formed, the extruding head proceeds to deposit the next layer of the article based upon the computer model of the article. This process is repeated in a layer-by-layer manner until the printed article is fully formed. Similarly, in direct pellet extrusion, pellets rather than filaments are used as the feed material, and the pellets are fed to an extruding head and are heated and deposited onto the substrate.

A variety of polymeric materials are known for use in additive manufacturing methods. Common polymeric materials used in additive manufacturing include acrylonitrile butadiene styrene (ABS), polyurethane, polyamide, polystyrene, and polylactic acid (PLA). More recently, high performance engineering thermoplastics have been used to produce printed articles with improved mechanical and chemical properties relative to common polymer materials. Such high-performance thermoplastics include, polyaryletherketones, polyphenylsulfones, polycarbonates, and polyetherimides.

While additive manufacturing methods can be used to rapidly form an article having any of various shapes and configurations, articles formed by additive manufacturing processes can suffer from weak inter-layer adhesion in the z-direction of the printed article.

Currently, additive manufacturing using material extrusion three-dimensional printing (ME3DP) based on FFF and FDM is considered a highly flexible and efficient additive manufacturing technique. In this process, a thermoplastic filament is heated and then “extruded” and fused to an underlying layer. This technique is viewed in that art as potentially useful for developing manufactured components with more complex geometries using computer-assisted design.

In addition to using the materials used as noted above, there have been further attempts to develop techniques using FFF for printing soft thermoplastic elastomers such as ethylene vinyl acetate (EVA), ethylene-propylene diene monomer in a polypropylene matrix (EPDM+PP), acrylonitrile-butadiene-styrene (ABS) and styrene-ethylene-butadiene-styrene (SEBS). However, such materials present challenges in processing using FFF to form articles. See, N Kumar et al., “3D Printing of Flexible Parts Using EVA Material,” Materials Physics and Mechanics 37, pp. 124-132 (2018); N. Kumar et al., “Additive Manufacturing of Flexible Electrically Conductive Polymer Compositions Using CNC-Assisted Fused Layer Modeling Process,” Journal of the Brazilian Society of Mechanical Sciences and Engineering, 40:175 (2018) and K. Elkins et al., “Soft Elastomers for Fused Deposition Modeling,” Virginia Polytechnic Institute and State University, presented in the International Solid Freeform Fabrication Symposium (1997).

As such materials are soft, they tend to lack adequate compression set and heat resistance for many applications. To provide better performance, they are generally prepared for use in the form of a compounded elastomer (i.e., a curable elastomer composition for vulcanization including a curable polymer, one or more fillers, and generally also a cure system). As such materials are processed, they form a network structure in the crosslinked rubber system that can negatively impact the ability to fabricate objects using layered FFF technology. There is a need in the art for development of such a technique as such networked structures offer the potential of finished products which should include strong interfacial bonding provided there was the ability to form them successfully with FFF or another additive technology.

It is further an issue in the art for development of additive processible compounds in the elastomer area that the processing characteristics of a fully compounded curable elastomeric composition are quite different from the processing characteristics of thermoplastics such as those noted above that are typically used in FFF processing. When attempting to introduce elastomers to additive manufacturing processes, particularly in the case of thermoset elastomers, in a curable compounded form, caution has to be taken to keep the materials below their cure temperature for the purpose of processing the material before curing it. Such materials when not heated present further challenges for processing as they have a high viscosity (a problem usually addressed by application of heat), and the need to prevent and hold off forming of crosslinks while processing and prior to intentional curing.

Feeding of flexible filaments using currently available three-dimensional printing equipment also poses a challenge due to such viscosity and cure-prevention needs, including preventing problems which arise due to buckling of the filament. Recent attempts to produce printed nitrile rubber using an additive ram material extruder (ARME) have been attempted with a carbon-filled nitrile rubber, however, on-bed material shrinkage occurred in printing even in view of use of various patterning intended to reduce the overall impact of shrinkage in the printing process. See, D. Kazmer et al., “Additive Ram Material Extrusion and Diddling of Fully Compounded Thermoset Nitrile Rubber,” Polymer Composites, (July 2021) pp. 1-12.

Fluorine-containing elastomers including both fluoroelastomers (FKMs) and perfluoroelastomers (FFKMs) are chemically- and plasma-resistant and can be used also in certain compositions suitable for high-temperature and high-pressure applications. They are employed in a variety of end applications, notably as sealing and gasketing components for use in pharmaceutical and semiconductor manufacture, where chemical- and/or plasma-resistance as well as material purity are desired traits, as well as oil-field and fluid handling applications due to their ability to withstand harsh chemicals and high temperatures and pressures. However, fluorine-containing elastomers are materials known in the art to be difficult to process, and generally require careful compounding to ensure they are well-blended in a compound and are not prematurely cured. They are also reasonably expensive to manufacture requiring cleanroom facilities in some cases, as well as extrusion followed by compression molding.

There is a need in the art for methods of processing soft elastomer materials, thermoset elastomers and other elastomeric materials not previously believed to be employed in additive manufacturing such as by FFF or FDM, and particularly, to be able to more inexpensively form articles from fluorine-containing elastomers, which are known to be difficult and/or expensive to process and which have properties and processing challenges that otherwise support the currently held view in the art that such materials are not capable to be successfully processed using additive manufacturing, and to eliminate issues with buckling of material and premature curing.

There is also a need in the art to provide such methods which, when attempting to additively print articles from FKMs and FFKMs and similar soft elastomers can also provide sufficient reproducibility for use in product development in order to be able to provide consistent parts with good interlayer adhesion, such as seals, gaskets and other components in smaller and large sizes and/or for specialty applications having high-performance specification requirements and varying end applications. Such specialty parts can be difficult to produce using traditional manufacturing techniques. Further, it would be beneficial and there is a need in the art for such methods that can provide sufficient yield and are more simplified in operation and use, and that can also provide lower manufacturing costs associated with reduction in waste, reduction in the amount of raw material required, and higher yields.

### BRIEF SUMMARY OF THE INVENTION

The invention herein includes an additive manufacturing method for forming a fluorine-containing elastomer article, comprising providing a curable fluoropolymer composition, comprising at least one curable fluoropolymer; providing an additive manufacturing printer apparatus comprising a ram material extruder, wherein the ram material extruder comprises a ram device operable for extrusion under pressure and a printer nozzle; introducing the curable fluoropolymer composition to the ram material extruder; applying heat to the ram device, including the printer nozzle thereof; and applying pressure to the ram device to extrude the curable fluoropolymer composition; and printing, using the additive manufacturing printer apparatus, at least one layer of the extruded curable fluoropolymer composition exiting from an outlet of the printer nozzle onto a substrate to form the fluorine-containing elastomer article.

In one embodiment of the method herein, the ram material extruder may further comprise a drive mechanism such that the method may further comprise operating the drive mechanism to apply pressure to the ram device. The drive mechanism may comprise a drive motor in operable connection with a timing belt.

In another embodiment of the method, the step of applying pressure may comprise operating the ram extruder to apply pressure by movement of a platen over at least one lead screw that is in operable communication with the timing belt, and rotating the at least one lead screw using the timing belt on the drive motor. In one embodiment, there are at least two lead screws. The ram device may comprise a piston having an exterior surface and a barrel having a first end, a second end and an interior surface that defines an interior space, wherein the barrel is configured to receive the piston after passing through a first opening in the first end of the barrel and wherein the second end of the barrel is located to be in communication with the printer nozzle, and the method further comprises passing the piston into the interior space of the barrel such that the exterior surface of the piston faces the interior surface of the barrel while applying pressure to the ram device.

In the method, the step of introducing the curable fluoropolymer composition may comprise loading the curable fluoropolymer composition into the barrel between the printer nozzle and the first end of the barrel. Further, in the method, the step of applying heat to the ram device further may further comprise generating heat using a heating mechanism with the ram material extruder; or may further comprise heating the curable fluoropolymer composition to a temperature that is sufficient to initiate flow of the curable fluoropolymer composition within the ram device and that is below a temperature at which significant curing of the curable fluoropolymer composition occurs. Further, the method may further comprise heating the curable fluoropolymer composition to a temperature that is below a temperature corresponding to a time, T2, associated with the curable fluoropolymer composition as determined using a test method of ASTM D2084 on a rubber process analyzer. The curable fluoropolymer composition may be heated to a temperature which is below a temperature at which significant curing occurs.

In the method, the curable fluoropolymer composition comprises at least one curable fluoropolymer. The at least one curable fluoropolymer may be partially fluorinated. The at least one curable fluoropolymer in the curable fluoropolymer composition may be a curable perfluoropolymer. The at least one curable fluoropolymer may be a perfluoropolymer and the start of curing of the perfluoropolymer may be shown by thermal analysis using a differential scanning calorimeter.

In embodiments herein, the curable fluoropolymer composition may be heated to a temperature that is about 20° C. to about 250° C., or to a temperature that is about 70° C. to about 250° C., or to a temperature that is about 100° C. to about 250° C., or to a temperature that is about 105° C. to about 200° C., or to a temperature that is about 115° C. to about 160° C.

In the method in an embodiment herein, the printer nozzle may comprise a nozzle body and a nozzle tip, wherein the nozzle body defines a tapered interior chamber having an inlet for receiving the curable fluoropolymer composition extruded through the ram device and an outlet in communication with an inlet to the nozzle tip, the nozzle tip has an interior surface extending from the inlet of the nozzle tip to the outlet of the printer nozzle. In such an embodiment, the method may further comprise printing the extruded curable fluoropolymer composition by applying heat and pressure to extrude the curable fluoropolymer composition through the inlet of the nozzle body, the outlet of the nozzle body, the inlet of the nozzle tip and the outlet of the printer nozzle. In the method, the nozzle tip may have a reduced diameter area on an outlet end thereof for directing the extruded curable fluoropolymer composition through the outlet of the printer nozzle.

In an embodiment herein, the fluorine-containing elastomer article may be a seal and the inner diameter of the printer nozzle may approximately be the same as a longitudinal cross-sectional outer diameter of the seal. The inner diameter of the printer nozzle outlet may be at least about 0.2 mm as measured transversely across the printer nozzle outlet. In another embodiment, the inner diameter of the printer nozzle outlet may be about 0.2 mm to about 3.3 mm, or about 0.4 mm to about 1.6 mm as measured transversely across the printer nozzle outlet.

The ram material extruder may further comprise a drive mechanism having a drive motor, and the drive motor may provide sufficient torque to overcome friction between the curable fluoropolymer composition within the ram device while providing sufficient pressure to extrude the material through the ram device and out of the outlet of the printer nozzle.

The drive motor may be a stepper motor having a geared transmission.

The method may further comprise analyzing the curable fluoropolymer composition to estimate a storage modulus for determining printing parameters for printing the curable fluoropolymer composition. The storage modulus is preferably estimated, e.g., by using a Rubber Process Analyzer or parallel plate rheometry or other suitable method to optimize the printing parameters for the curable fluoropolymer composition.

In embodiments herein, the additive manufacturing printer apparatus may further comprise a pre-cooler, although this is not necessary when using a ram material extruder. If a pre-cooler is used, the method may further comprise cooling the curable fluoropolymer composition before introducing the curable fluoropolymer composition to the ram device. In further embodiments herein, the substrate may optionally comprise a frictional surface. The method may further optionally comprise coating the substrate with an adhesive. The substrate may be a base plate of a seal, e.g., the base plate of a bonded seal or bonded gasket. In such instance, the method may further comprise printing the extruded curable fluoroelastomer composition onto the base plate. Seals may be selected from any gasket or seal. The base plate in embodiments herein may be a mold having an upper mold plate surface having an upper surface defining a cavity and/or a lower mold plate having an upper surface defining a cavity, and the method may further comprise printing the extruded curable fluoropolymer composition as a preform into one or both of the cavities on the upper surface of the upper mold plate surface and/or the lower mold plate of the mold.

In another embodiment herein, a support structure may be positioned on the base plate for assisting in shape retention of the extruded curable fluoropolymer composition and the method may further comprises printing the extruded curable fluoropolymer using the support structure. The support structure may be a permanent or a removable fixture-like support. The support structure may be formed of various materials including thermoplastic materials, metals or metal alloys. The support structure may also be itself formed by additive manufacturing and/or may be made of a dissolvable material.

In other embodiments herein, the additive manufacturing apparatus is capable of printing at a temperature of less than about 250° C., preferably less than about 200° C. and more preferably less than about 160° C. The additive manufacturing apparatus may also be capable of printing in each of these instances at a temperature of at least about 20° C.

The invention also includes herein a fluorine-containing elastomer article formed by the method described above, wherein the article comprises an at least partially cured fluoroelastomer. Such article(s) may comprise an at least partially cured perfluoroelastomer. The curable fluoropolymer composition used in the method to form the article, may comprise at least one curable fluoropolymer having a functional group for reacting with a curative and at least one curative capable of reacting with the functional group. The curable fluoropolymer composition may further comprise at least one filler. The curable fluoropolymer composition used to form the article is preferably sufficiently tacky so as to self-adhere to the substrate, but is preferably still able to be removable from the substrate while substantially retaining its structural integrity. The curable fluoropolymer composition may be able to be processed without curing or at least partially cured to a degree greater than 0% but less than about 25% during printing. The curable fluoropolymer composition used to form the articles in embodiments herein may comprise one or more additional curable fluoropolymers or one or more additional curable perfluoropolymers. In such case, the curable fluoropolymer composition may also comprise one or more additional curatives to cure the one or more additional curable fluoropolymers or the one or more additional perfluoropolymers.

The invention also includes a system for forming three-dimensional, additively manufactured fluorine-containing elastomer articles, comprising: (i) a curable fluoropolymer composition; and (ii) an additive manufacturing printer apparatus capable of forming a three-dimensional printed article, the apparatus comprising: a programmable additive manufacturing printer; a ram material extruder comprising a ram device operable for receiving the curable fluoropolymer composition and extruding the curable fluoropolymer composition under pressure, a printer nozzle having an inlet and an outlet, and a drive mechanism for applying pressure to the ram device, wherein the ram device is operated according to instructions from the programmable additive manufacturing printer; and a heating device for applying heat to the ram device, including the printer nozzle thereof; wherein the printer nozzle is configured to receive the curable fluoropolymer composition through the inlet of the printer nozzle under pressure and to allow for heated extrusion of the fluoropolymer composition through the printer nozzle outlet for printing a fluorine-containing elastomer article.

In the system, the drive mechanism may comprise a drive motor in operable connection with a timing belt. The drive motor may be a stepper motor having a geared transmission. The ram material extruder may further comprise at least one lead screw and a movable platen capable of moving over the at least one lead screw, wherein the at least one lead screw is in operable communication with the timing belt. In one embodiment herein, there are two lead screws.

In embodiments of the system herein, the ram device may further comprise a piston having an exterior surface and a barrel having a first end, a second end and an interior surface that defines an interior space, wherein the barrel is configured to receive the piston after passing through a first opening in the first end of the barrel and wherein the second end of the barrel is located to be in communication with the printer nozzle. The piston may be within the interior space of the barrel so that the exterior surface of the piston faces the interior surface of the barrel.

The heating device of the system is preferably capable of heating the curable fluoropolymer composition to a temperature that is sufficient to initiate flow of the curable fluoropolymer composition within the ram device and that is below a temperature at which significant curing of the curable fluoropolymer composition occurs. The heating device may be capable of heating the curable fluoropolymer composition to a temperature that is below a temperature corresponding to a time, T2, associated with the curable fluoropolymer composition as determined using a test method of ASTM D2084 on a rubber process analyzer.

The additive manufacturing printer apparatus is preferably capable of forming a three-dimensional printed article comprising a fluoroelastomer that is at least partially fluorinated. The additive manufacturing printer apparatus is preferably capable of forming a three-dimensional printed article comprising a perfluoroelastomer. The additive manufacturing apparatus is preferably capable of forming an article selected from a gasket and a seal. The article may be printed on a base plate. In one embodiment, the base plate is a mold having an upper mold plate having an upper surface and/or a lower mold plate surface having an upper surface, wherein each upper surface defines a cavity, and the article may be printed on the cavity of the upper surface of the upper mold plate and/or of the upper surface of the lower mold plate of the mold.

In another embodiment herein, a support structure is positioned on the base plate for assisting in shape retention of the extruded curable fluoropolymer composition. The support structure may be a removable or permanent fixture or fixture-like support. The support structure may comprise one or more of a thermoplastic material, a metal or a metal alloy. The support structure may itself be made by additive manufacturing and/or may comprise a dissolvable material.

The ram device in the system may further comprise a load cell that acts as a sensor for monitoring pressure within the ram device.

The heating device in the system may be capable of heating the curable fluoropolymer composition to a temperature that is about 20° C. to about 260° C., or that is about 70° C. to about 250° C., or that is about 100° C. to about 250° C., or that is about 105° C. to about 200° C., or that is about 115° C. to about 160° C.

The heating device may be positioned on the ram device of the system. The system printer nozzle may comprise a nozzle body and a nozzle tip, and the nozzle body may define a tapered interior chamber having an inlet for receiving the curable fluoropolymer composition extruded through the ram device and an outlet in communication with an inlet to the nozzle tip, wherein the nozzle tip has an interior surface extending from the inlet of the nozzle tip to the outlet of the printer nozzle. The nozzle tip may have a reduced diameter area at nozzle outlet end thereof for directing the extruded curable fluoropolymer composition through the outlet of the printer nozzle. The length of the printer nozzle, as measured longitudinally along the printer nozzle, from an inlet to the nozzle body to the printer nozzle outlet may be about 1 to about 5 times the inner diameter of the nozzle outlet, and is preferably about 2 times the inner diameter of the nozzle outlet. The inner diameter of the nozzle outlet may be about 0.4 mm to about 1.6 mm, and may be preferably about 0.8 mm.

The drive mechanism of the system can optionally be capable of providing sufficient torque to overcome friction, if it is an issue, between the curable fluoropolymer composition within the ram device while providing sufficient pressure to extrude the curable fluoropolymer composition through the ram device and out of the outlet of the printer nozzle. While not necessary, the system may optionally comprise a pre-cooler, if desired, for cooling the curable fluoropolymer composition before introducing it to the ram device.

The additive manufacturing printer apparatus in an embodiment herein is capable of printing at a temperature of less than about 250° C., preferably less than about 200° C. and more preferably less than about 160° C. In each case, it is also possible that the additive manufacturing printer apparatus is capable of printing at temperature of at least about 20°.

The invention herein may also include an additive manufacturing method, based on fused filament manufacturing, for forming a fluorine-containing elastomer article, comprising providing a filament formed of a curable fluoropolymer composition; providing an additive manufacturing printer having a drive mechanism and a printer nozzle; feeding the filament into an additive manufacturing printer through the drive mechanism and through a longitudinal passage defined by an interior wall of a support tube, wherein the support tube extends from a first end to a second end, and wherein the second end of the support tube is positioned to be in fluid communication with an inlet to a printer nozzle; applying heat to the filament and printing successive layers of the filament exiting an outlet of the nozzle onto a substrate using the additive manufacturing printer to form the fluorine-containing elastomer article.

In this embodiment of the method noted above, the filament may be fed from a feed roller. The filament is preferably formed by extruding the curable fluoropolymer composition. The filament may be cooled prior to introducing the filament to the support tube. A cooling method may be applied prior to introducing the filament to the tube for stiffening the filament and reducing the possible buckling. The filament may be cooled prior to entering the drive mechanism.

In one embodiment of this method, the filament, which includes the curable fluoropolymer composition may be heated to a temperature that is sufficient for flow of the curable fluoropolymer composition within the printer apparatus and that is below a temperature at which significant curing occurs. For example, the filament may be heated to a temperature that is below a temperature corresponding to a time, T2, associated with the curable fluoropolymer composition as determined using a test method of ASTM D2084 on a rubber process analyzer (RPA), which test methods as are known in the art. Suitable RPAs are available commercially. One suitable RPA, e.g., is available from Alpha Technologies Company, as RPA Model 2000. Such a temperature allows for depositing of the filament onto prior layers within a time that is below T2 to prevent or avoid curing until curing is desired, e.g., during a post-cure heating step.

The curable fluoropolymer may be partially fluorinated or a curable perfluoropolymer. In such a method when the fluoropolymer is a perfluoropolymer, and a filament feed is used, the filament may be heated to a temperature that is enables flow of the curable perfluoropolymer, and that is below the temperature at which significant curing occurs. For example, the start of curing for a perfluoropolymer may be shown by thermal analysis using a differential scanning calorimeter (DSC). Curing characteristics will vary substantially depending on the curable FKM(s) and/or FFKM(s) selected for forming the filaments and particularly due to the cure system being employed. Thus, a selected compound DSC curve may be consulted to determine the desired heating temperature.

In example embodiments, for certain types of materials, the curable fluoropolymer that is partially, substantially or fully fluorinated may be heated to a temperature of about 100° C. to about 250° C., and preferably a temperature of about 105° C. to about 200° C., and more preferably a temperature that is about 115° C. to 160° C, with the understanding that such temperatures would be adjusted depending on the compound and its cure system.

In this method embodiment, the heat is preferably generated by a heating mechanism in the additive manufacturing printer, preferably in the print head. The drive mechanism in this embodiment of the additive manufacturing printer preferably comprises a drive wheel and a support wheel, and the method may further comprise passing the filament through the drive wheel and the support wheel prior to entering the first end of the support tube. In an alternative embodiment, the first end of the support tube extends upwardly through the drive mechanism between the support wheel and the drive wheel to support the filament as it leaves a feed roller. The support tube wall may optionally define a side opening extending transversely through the support tube wall and the wall around the opening may be contoured to the shape of the drive wheel, wherein the method may then further comprise feeding the filament so that it contacts the drive wheel in the area of the side opening as the filament passes through the drive mechanism.

In a further embodiment of this method, the drive mechanism may comprise geared drive rollers and method may further comprise feeding the filament through the geared drive rollers. The support tube may extend from below the geared drive rollers. A portion of the support tube may further extend above the geared drive rollers such that the method may further comprise feeding the filament through the portion of the support tube above the geared drive rollers and into the rollers. The method may also further comprise cooling the portion of the support tube that extends above the geared drive rollers.

In this embodiment of the method using filament feed, the outlet of the nozzle may define an opening that is preferably wider, as measured transversely across the opening, than an outer diameter of the heated filament as measured transversely before heating. The opening of the nozzle outlet in one embodiment may have a width, as measured transversely across the outlet opening in a widest dimension, that is about 10% to about 200% of the outer diameter of the filament as measured transversely before heating.

Also in this embodiment, one portion of the nozzle that extends from a printhead of the printer, may have a length measured from an inlet to the portion of the nozzle to the nozzle outlet, as measured longitudinally along the nozzle portion, that is about 5 to about 20 times the diameter of the filament prior to heating. In another embodiment, the nozzle may have a length in the heated portion thereof, as measured longitudinally along the heated portion of the nozzle, that is about 1 to about 10 times an outer diameter of the heated filament. In such an embodiment, the nozzle filament formed of a curable fluoropolymer composition prior to heating may preferably have an outer diameter of about 0.2 mm to about 20 mm, and more preferably an outer diameter of about 1.0 mm to about 3.0 mm.

The additive manufacturing printer in this embodiment of the method using a filament feed, may include a drive motor for operating the drive mechanism that provides sufficient torque to overcome friction between the filament and the additive manufacturing drive printer while providing sufficient pressure to extrude the material through the additive manufacturing printer and out the nozzle. In one embodiment hereof, the drive motor may be a stepper motor having a geared transmission, which may include at least one planetary gear, to increase the torque of the stepper motor.

The invention further includes an article formed by a heated filament comprising a curable fluoropolymer composition using an additive manufacturing apparatus, wherein the article comprises a fluoroelastomer. The additive manufacturing apparatus in one embodiment may be a fused filament fabrication apparatus. The curable fluoropolymer composition may include a curable fluoropolymer, and in one embodiment, the curable fluoropolymer is perfluorinated such that it is a curable perfluoropolymer and the article comprises a perfluoroelastomer. The curable composition may comprise at least one curable fluoropolymer and at least one curative. The composition may further comprise at least one filler. In one embodiment herein using a fused filing fabrication apparatus as noted above, the filament may have a diameter of about 0.2 mm to about 3.0 mm, and preferably about 1.0 mm to about 2.0 mm.

In another embodiment the method using a fused filament fabrication-type apparatus, the method may further comprise analyzing a curable fluoropolymer compound using, e.g., DMA, parallel plate rheometry, or other method to estimate a storage modulus to determine, such as to optimize, printing parameters. In embodiments as noted above, using a ram material extruder as noted above, the curable fluoropolymer compound may also be analyzed, including estimating the storage modulus, using a Rubber Process Analyzer, parallel plate rheometry, or other method suitable to determine properties to optimize printing parameters.

The invention also includes a curable fluorine-containing composition for use in an additive manufacturing composition, comprising a curable fluoropolymer having a functional group for reacting with a curative; and a curative capable of reacting with the functional group. In embodiments noted above using a fused filament fabrication-type apparatus, the fluorine-containing composition may have a torque of about 0.78 dNm when it is about 10% cured to about 28.01 dNm when it is about 90% cured. Such torque may be measured by RPA in accordance with ASTM D2084 test methodology.

In embodiments herein, the curable fluorine-containing composition may be sufficiently tacky so as to self-adhere on a substrate, but is still able to be removable from a substrate while substantially retaining the structural integrity of the fluorine-containing material deposited on the substrate. In such embodiments, the curable composition is preferably able to be processed without curing occurring or with partial curing to a degree greater than 0% but less than about 25% during printing using an additive manufacturing apparatus. The fluorine-containing compositions herein may comprise a curable fluoropolymer that is a curable perfluoropolymer. They may comprise one or more additional curable fluoropolymers or one or more additional perfluoropolymers. The composition may then further comprise one or more additional curatives to cure the one or more additional curable fluoropolymers or one or more additional perfluoropolymers.

The invention further includes an additive manufacturing apparatus capable of forming a three-dimensional printed article comprising an elastomer. This apparatus is useful when a filament fed elastomer composition is used. This embodiment of the apparatus comprises: a printer drive mechanism configured to facilitate passage of a curable polymer filament passing through the printer drive mechanism; a drive motor in operable communication with the printer drive mechanism, wherein the drive mechanism comprises a geared transmission, which may include one or more planetary drive wheels; and a printhead comprising a nozzle having an inlet for receiving polymeric filament and an outlet for heated extrusion of a curable polymeric filament onto a substrate.

In this embodiment, the printer drive mechanism of the apparatus may comprise a drive roller and a support roller, and the apparatus may further comprise a support tube situated to extend beneath the printer drive mechanism, wherein the drive roller is preferably positioned to contact a filament fed into the tube within the printer drive mechanism. The support tube may extend from a lower surface of the printer drive mechanism for communication between the printer drive mechanism and the inlet of the nozzle. The support tube has a first end preferably positioned above the printer drive mechanism and a second end which is preferably proximate to the inlet of the nozzle, wherein the support tube is preferably configured to support a filament passing through the first end of the support tube and exiting through the second end of the support tube. The support tube preferably has a longitudinally extending wall having an interior surface defining a longitudinal passage from a first end of the tube to a second end of the tube, and an opening extending transversely through the wall of the tube from the interior surface to an exterior surface of the tube, for facilitating direct contact between the drive roller and a filament passing through the longitudinal passage of the support tube. The first end of the support tube may be positioned to receive a curable polymer filament leaving a feed roller while avoiding buckling of the filament.

This embodiment of the apparatus may further comprise a pre-cooler for cooling the filament before the filament enters the printer drive mechanism.

The printer drive mechanism of this embodiment of the apparatus may be configured to facilitate passage of a curable fluoropolymer filament passing through the printer drive mechanism and the article may then comprise a fluoroelastomer. The printer drive mechanism may also be configured to facilitate passage of a curable perfluoropolymer filament passing through the printer drive mechanism and the article may then comprise a perfluoroelastomer.

The drive motor of this embodiment of the apparatus may be a stepper motor and the geared transmission may include planetary gears that are preferably configured to provide a torque of about 0.2 to about 4. It will be understood, however, that the torque may be adjusted for different printing conditions and nozzle configurations.

The outlet of the nozzle in such an embodiment may be about 0.2 mm to about 20 mm, and preferably about 1.0 mm to about 3.0 mm.

In this embodiment of the apparatus, the substrate may further comprise a frictional surface to improve adhesion of non-tacky extruded curable polymer onto the substrate. Such a frictional surface may comprise, e.g., an adhesive.

The additive manufacturing apparatus in this embodiment is preferably capable of printing at a temperature of less than about 250° C., and more preferably at a temperature of less than about 200° C., and most preferably at a temperature of less than about 160° C.

The invention also includes, in a further embodiment, an additive manufacturing apparatus capable of forming a three-dimensional printed article comprising an elastomer. The composition is preferably provided in this apparatus as a filament feed material. In this embodiment, the apparatus comprises: a printer drive mechanism configured to facilitate passage of a curable polymer filament passing through the printer drive mechanism, and comprising geared drive rollers; a drive motor in operable communication with the printer drive mechanism; a printhead comprising a nozzle having an inlet for receiving polymeric filament and an outlet for heated extrusion of a curable polymeric filament onto a substrate; and a pre-cooler for cooling the filament before it enters the printer drive mechanism.

In such an embodiment, the apparatus may further comprise a support tube situated to extend beneath the printer drive mechanism. The support tube may extend from below the geared drive rollers for communication through the support tube between the geared rollers of the printer drive mechanism and the inlet of the nozzle. The support tube may have a first end and a first portion positioned above the printer drive mechanism and a second portion which extends from below the geared drive rollers to a second end that is proximate to the inlet of the nozzle. The first portion of the support tube may be situated within or be part of the pre-cooler.

The first end of the support tube may be positioned to receive a curable polymer filament leaving a feed roller while avoiding buckling of the filament. The pre-cooler may have walls that define a cavity for receiving a coolant. The pre-cooler walls may also define a bore for allowing passage of the filament for cooling the filament before passing through the geared drive rollers. The printer drive mechanism may be configured to facilitate passage of a curable fluoropolymer filament passing through the printer drive mechanism and the article comprises a fluoroelastomer. The printer drive mechanism may further be configured to facilitate passage of a curable perfluoropolymer filament passing through the printer drive mechanism and the article comprises a perfluoroelastomer.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a schematic flowchart representation of an apparatus according to one embodiment of the invention;

FIG. 1A is a schematic flowchart representation of a preferred embodiment of the apparatus of FIG. 1;

FIG. 2 is a perspective view of an apparatus according to a preferred embodiment of the invention herein;

FIG. 2A is a longitudinal cross-sectional view of a portion of the apparatus of FIG. 2 taken along lines 2A-2A;

FIG. 3 is a side elevational view of a support tube between a drive wheel and support wheel with a polymeric filament extending therethrough for use in the apparatus of FIG. 2;

FIG. 3A is a side elevational view of the support tube of FIG. 3 absent the drive wheel and support wheel;

FIG. 4 is a bottom elevational view of a nozzle outlet of a prior art additive manufacturing printer;

FIG. 4A is a bottom elevational view of a nozzle outlet for use in an apparatus according to a preferred embodiment of the invention;

FIG. 5 is a schematic flowchart representation of steps for use in the invention herein;

FIG. 6 is a graphical representation of filament length in mm over applied temperature for an extruded perfluoropolymer filament;

FIG. 7 is an example of a geared transmission for use in an embodiment herein;

FIG. 7a is an example of a planetary gear for use in the geared transmission of FIG. 7;

FIG. 8 is a differential scanning calorimeter graphical representation of the thermal behavior of the material in Sample 1;

FIG. 9 is a differential scanning calorimeter graphical representation of the thermal behavior of the material in Sample 2;

FIG. 10 is a differential scanning calorimeter graphical representation of the thermal behavior of the material in Sample 3;

FIG. 11 is a cross-sectional view of a cooling apparatus as in FIG. 11A taken along lines 11-11 used in conjunction with an apparatus according to one embodiment of a printer drive mechanism within a printing apparatus herein;

FIG. 11A is a top elevational view of the cooling apparatus of FIG. 11;

FIG. 12 is a graphical representation of storage modulus (G′) in Pa against temperature (° C.) for an exemplary embodiment herein;

FIG. 13 is a schematic flowchart representation of a further system according to another embodiment of the invention including an additive manufacturing printer apparatus having a ram material extruder;

FIG. 14 is a schematic flowchart representation of the steps in a method in the invention herein using an apparatus such as that of FIG. 13;

FIG. 15 is a front, bottom perspective view of a ram material extruder which may be used in the system of FIG. 13 and the method of FIG. 14;

FIG. 16 is a top elevational view of the ram material extruder of FIG. 15;

FIG. 17 is a longitudinal, cross-sectional view of the ram material extruder of FIG. 16 taken along line 17-17;

FIG. 18 is a longitudinal, cross-sectional view of the ram material extruder of FIG. 17 taken along line 18-18;

FIG. 19 is an enlarged view of a portion of FIG. 17 showing the nozzle area of the ram material extruder;

FIG. 20 is a photographic image of a base plate for a gasket;

FIG. 21 is a photographic image of a base plate for a seal;

FIG. 22A is a photographic image of a printed gasket incorporating a fluoroelastomeric printed seal on the base plate of FIG. 20;

FIG. 22B is a photographic image of a printed gasket incorporating a perfluoroelastomeric printed seal on the base plate of FIG. 20;

FIG. 23A is a photographic image of a seal incorporating fluoroelastomeric seals printed on the base plate of FIG. 21;

FIG. 23B is a photographic image of a seal incorporating perfluoroelastomeric seals printed on the base plate of FIG. 21;

FIG. 24 is a perspective view of an embodiment of a ram material extruder for use in the apparatus and methods herein;

FIG. 25 is a transverse cross-sectional view of a sample support structure for use in the methods herein;

FIG. 26 is a perspective view of the support structure of FIG. 25;

FIG. 27 is a top elevational view of an assembly of the support structure of claim 25 having a printed preform positioned therein; and

FIG. 28 is a perspective view of the assembly of FIG. 27.

### DETAILED DESCRIPTION OF THE INVENTION

The invention herein includes an additive manufacturing method for forming a fluorine-containing elastomer article; articles formed from the method that uses an additive manufacturing apparatus to extrude a curable fluoropolymer composition for printing, wherein the curable fluoropolymer composition may be provided, e.g., in filament form in some embodiments herein or in small pieces in other embodiments; curable fluorine-containing compositions for use in additive manufacturing compositions, including a curable fluoropolymer having a functional group for reacting with a curative, and a curative capable of reacting with the functional group; and an additive manufacturing system including a ram extruder and a curable fluoropolymer composition and a method of forming articles using the system and method steps described.

As used herein, “additive manufacturing” can include a variety of manufacturing techniques and apparatus suitable for preparing an article by depositing a heated material in layers on a substrate in a layer-by-layer manner to form an article. The methods, articles and compositions herein can be used in any of various additive manufacturing processes, including but not limited to three-dimensional printing, and material extrusion methods such as fused deposition modeling (“FDM”), fused-filament fabrication (“FFF”) and direct pellet extrusion, and use of an additive ram material extruder (ARME), among others. Preferably, the additive manufacturing process in some embodiments herein is a material extrusion method, such as FFF or FDM, or a method of printing employing an ARME or other ram extrusion printing apparatus.

In FDM or FFF processes, e.g., the curable polymer compositions herein are preferably provided in the form of an extruded filament. Preparing a filament is not necessary in embodiments using a ram material extruder herein, but a filament could be used as a feed material.

A computer model of an article to be printed can be provided, as is known in additive manufacturing, and the computer model would represent the article as a plurality of layers or cross sections. The article is then formed in a layer-by-layer manner as the filament is fed to an extruding nozzle at the exit of a typical additive manufacturing apparatus which, in FKM or FFF processes provides heat to the filament and extrudes the heated filament for depositing it on a build platform or substrate to form a layer of the article based on the computer model of the article. Heat is also applied to the nozzle in a ram material extruder method herein when the curable fluoropolymer composition is within the ram device, including in the nozzle end. Once deposited, the heated filament or extruded curable fluoropolymer composition exiting the nozzle hardens so as to form a layer of the article. A subsequent layer of filament or extruded curable polymer is deposited on the first layer of filament to form a subsequent layer of the article based on the computer model of the article. This process is repeated until all layers of the article are deposited so as to form the printed article. Once the article is complete, various finishing processes may be performed, such as a thermal cure of the article, or surface treatments, such as sanding to remove excess material.

When used in an additive manufacturing process to form a printed article as described herein, a curable fluoropolymer composition after printing is preferably crosslinked using a cure system and application of heat, such as by heating the composition to a temperature sufficient to induce initial curing of the curable fluoropolymer which creates some crosslinking of the material and/or to heat the composition to a temperature that substantially or fully crosslinks the composition at elevated temperatures upon formation of layers and/or during a post-cure step.

During processing through the apparatus and prior to passing through the nozzle, the filament or other curable fluoropolymer composition feed material is preferably only heated to a temperature sufficient to allow the curable fluoropolymer to flow through the apparatus, and to avoid or minimize curing of the fluoropolymer until a layer or layers are printed. During processing, it is preferred that the temperature allow for flow but is kept below a temperature at which curing occurs or, if curing is initiated, does not become too substantial. The curable fluoropolymer compositions as provided for use in an additive manufacturing process herein are flowable through the apparatus but are either not crosslinked or crosslinked only to some extent while entering into the heated nozzle in an FFF or FDM additive manufacturing apparatus or when entering a heated ram device or nozzle of a ram material extruder in other embodiments herein.

Curing will continue after the layers are deposited during the formation of the individual layers in the additive manufacturing process. In an FFF or FDM apparatus, the extrusion head or nozzle which may provide heat and allows for exit of the extruded filament, and in an apparatus including a ram material extruder, the barrel and/or the nozzle end of the ram device may be heated to provide heat necessary to induce the crosslinking as the material exits, deposits and cures in the deposited layers. Such crosslinking during the additive manufacturing process is believed to help strengthen a finished article by improving interlayer adhesion in the article.

Once the printed article is fully formed by the additive manufacturing process, a final thermal cure step may also be taken in which the printed article may undergo further crosslinking or post-curing. The temperatures and times desired may be varied depending on the curable fluoropolymer selected for the composition as well as the degree of crosslinking desired and the presence or absence of any curatives, co-curatives and/or cure accelerators, as well as the degree of crosslinking that already occurred, in some embodiments herein, if any, while the filaments passed through the additive manufacturing apparatus during an initial article formation step. Preferably, the majority of the curing of the curable fluoropolymer composition occurs during the final curing of the printed article through continued application of some level of heat or post-cure to the formed article.

Curing the curable fluoropolymer is believed to provide increased adhesion between layers of the printed article, which provides the printed articles with improved and more uniform mechanical properties, such as tensile strength and modulus while still providing the benefit of an elastomeric material to the article, including in instances where compression capability, strength, and resistance to chemicals, plasma, and high-temperature and/or high pressure conditions will be encountered for the printed article in use.

Other benefits of use of additive manufacture to print elastomeric articles includes improvement in manufacturing efficiency. Most elastomeric articles such as O-rings and gaskets encounter low yields from compression molding, particularly when attempting to make articles with more complex geometries. There are some instances where traditional compression molding limits the level of complex geometries achievable with such processes. Further with respect to most fluoroelastomer and perfluoroelastomer articles, there are high material costs for the initial curable fluoro- or perfluoropolymer such that flashing, lost pieces removed in molding and other issues contribute to higher manufacturing costs. Use of the precise nature of additive manufacturing three-dimensional printing reduces such process waste and can lower costs.

Further, the modifications introduced in the additive manufacturing process herein enable various commercially developed additive manufacturing apparatus to overcome challenges previously encountered in the art while attempting to form articles using thermoset and other softer and more viscous elastomers due to a lack of strength combined with a high viscosity in the extruded materials.

Such improvements allow for a resolution in preventing buckling of extruded filaments, printing in a controlled manner within unnecessary curing of the material during delivery from the apparatus nozzle, and issues that arise from friction in the apparatus interfering with the ability to extrude the material through the print head or nozzle of the apparatus as well as adhesion of extruded filament onto a receiving substrate surface.

In additive manufacturing processes using conventional polymers or certain thermoplastic elastomers as have been previously demonstrated, the layers of a printed article are joined primarily by the intermixing or melting of layers into one another by polymer diffusion. The curable fluoropolymer compositions of the present invention, as they are able to be extruded without premature curing when delivered in forming a printed article, allow for layers to join both by traditional interlayer adhesion as well as strengthening by continued curing and crosslinking as the article is printed layer-by-layer.

The curable fluoropolymer compositions herein may be used to form prototypes, parts and replacement parts for use in a variety of industries and in a variety of end applications, including oil and gas drilling and recovery, semiconductor processing, aerospace applications, seals and gaskets such as gaskets, seals, bonded gaskets, bonded seals, structural brackets, automotive applications, medical devices, prosthetics and implants, construction materials, and consumer products, among others. For example, the curable fluoropolymer compositions may be formed into three-dimensional articles used to form packaging; scaling assemblies, such as O-rings, V-rings, U-cups, gaskets, bonded gaskets, seals, bonded seals, bearings, valve seats, adapters, chevron back-up rings, tubing and other products.

The resulting articles, as they are formed from fluorinated or perfluorinated materials will also be solvent-, chemical-, and plasma-resistant, and enjoy good physical properties (tensile strength and modulus, e.g.) and elastomeric properties, thermal properties and compression set while being manufactured at a lower cost due to elimination of waste in materials.

In one embodiment of a method herein, a filament is provided that is formed to include a curable fluoropolymer composition. In other embodiments herein, such as those using a ram material extruder, a filament feedstock is not needed and a curable fluoropolymer composition may be provided in gum form in pieces, pellets, sections, etc. Such curable fluoropolymer compositions for use herein each include one or more curable fluorine-containing polymers also referred to herein a curable fluoropolymers generally.

Curable fluorine-containing polymers for use herein may be any suitable curable fluorine-containing polymer formed of one or more curable fluorine-containing monomer, one of which has a functional group to permit curing by reacting with one or more curing agents in a curing system. Curable fluorine-containing polymers may be partially fluorinated curable fluoropolymers that upon curing form a partially fluorinated elastomer (also referred to herein as a fluoroelastomer) or can be substantially or completely fluorinated (i.e., perfluorinated) curable perfluoropolymers that upon curing form perfluoroelastomers.

For making parts intended for end applications that will be used in high purity or clean environments or for downhole applications in which harsh chemicals and high-temperatures and pressures are encountered, the at least one curable fluoropolymer is a preferably a curable perfluoropolymer that will be useful for forming a perfluoroelastomer. A composition herein, whether a curable fluoropolymer composition that is partially fluorinated or curable perfluoropolymer composition that is substantially or completely fluorinated, may include only one fluoro- or perfluoropolymer or may include two or more such fluoro- or perfluoropolymers in the composition which when used and/or cured to would form either an elastomer article having only a single fluoro- or perfluoroelastomer, or when two or more are used, would form an article having a blended perfluoroelastomer. Further curable fluoropolymers may be blended with curable perfluoropolymers to make partially fluorinated blended fluoroelastomers.

As used in this application, “perfluoroelastomer” or “cured perfluoroelastomer” unless otherwise indicated, includes any cured elastomeric material or composition that is formed by curing a curable perfluoropolymer(s) such as the preferred curable perfluoropolymers in the curable compositions described herein.

A “curable perfluoropolymer” (sometimes referred to in the art as a “perfluoroelastomer” or more appropriately a “perfluoroelastomer gum”) that is suitable to be used to form a cured perfluoroelastomer is a polymer that is substantially completely fluorinated, and which is preferably completely perfluorinated, on its polymeric backbone. It will be understood, based on this disclosure, that some residual hydrogen may be present in some perfluoroelastomers within the crosslinks of those materials due to use of hydrogen as part of a functional crosslinking group. Cured materials, such as perfluoroelastomers are cross-linked polymeric structures.

The curable perfluoropolymers that are used in preferred perfluoroelastomeric compositions herein to form articles by additive manufacture that include cured perfluoroelastomers upon cure are formed by polymerizing one or more perfluorinated monomers, one of which is preferably a perfluorinated cure site monomer having a cure site, as noted above, i.e., a functional group to permit curing. The functional group may either be or may include a reactive group that may not be perfluorinated. Two or more curable fluoro- or perfluoropolymers, and preferably at least one optional curative (curing agent), may be preferably combined herein in a composition that is then cured forming the resulting crosslinked, cured fluoroelastomeric compositions, and preferably perfluoroelastomeric compositions as described herein.

As used herein, the curable fluorine-containing elastomeric compositions may be curable perfluoropolymer compositions which include only one curable perfluoropolymer or a blend of two or more such curable polymers in a composition, each of which, if perfluorinated, is formed by polymerizing two or more perfluorinated monomers, including at least one perfluorinated cure site monomer which has at least one functional group (cure site) to permit curing. Such curable perfluoropolymer materials are also referred to generally as FFKMs in accordance with the American Standardized Testing Methods (ASTM) standardized rubber definitions and as described above herein in ASTM Standard D1418-17, incorporated herein by reference in relevant part.

As used herein, “compression set” refers to the propensity of an elastomeric material to remain distorted and not return to its original shape after a deforming compressive load has been removed. The compression set value is expressed as a percentage of the original deflection that the material fails to recover. For example, a compression set value of 0% indicates that a material completely returns to its original shape after removal of a deforming compressive load. Conversely, a compression set value of 100% indicates that a material does not recover at all from an applied deforming compressive load. A compression set value of 30% signifies that 70% of the original deflection has been recovered. Higher compression set values generally indicate a potential for seal leakage. Articles formed using three-dimensional additive manufacturing and a layer-by-layer forming process once fully cured can achieve elastomeric properties such as compression set, physical properties, such as tensile strength and tensile modulus, and chemical- and plasma-resistance properties suitable for use in at least the same end applications and environments in which perfluoroelastomers are currently employed in the art.

As described herein, the invention may include curable fluorine-containing elastomer compositions, including curable perfluoroelastomer or curable fluoroelastomer compositions, and molded articles formed from such curable fluorine-containing elastomer compositions.

Such perfluoroelastomeric compositions preferably include at least one, and more preferably two or more curable perfluoropolymers, preferably perfluoro-copolymers, at least one of which has a high content of tetrafluoroethylene (TFE). Other suitable co-monomers may include other ethylenically unsaturated fluoromonomers. If two such perfluoropolymers are used in a blend, and both preferably have TFE or another similar perfluorinated olefin monomer. Each curable perfluoropolymer may also preferably have one or more perfluoroalkylvinyl ethers (PAVEs), which include alkyl or alkoxy groups that may be straight or branched and which may also include ether linkages, wherein preferred PAVEs for use herein include, for example, perfluoromethylvinyl ether (PMVE), perfluoroethylvinyl ether (PEVE), perfluoropropylvinyl ether (PPVE), perfluoromethoxyvinyl ether and other similar compounds, with especially preferred PAVEs being PMVE, PEVE and PPVE. The PAVEs may be used alone or in combinations of the above-noted PAVE types within the curable perfluoropolymers and in the ultimate curable compositions so long as the use is consistent with the invention as described herein.

Perfluoropolymers are preferably co-polymers of TFE, at least one PAVE, and at least one perfluorinated cure site monomer that incorporates a cure site or functional group to permit crosslinking of the curable polymer. The cure site monomers may be of a variety of types with preferred cure sites noted herein. Preferred cure sites include those having a nitrogen-containing group, however, other cure site groups such as carboxyl groups, alkylcarbonyl groups, or halogenated groups having, e.g., iodine or bromine as well as other cure sites known in the art may also be used, particularly since additional curable fluoropolymers or perfluoropolymers beyond a first and/or second curable perfluoropolymer may be provided to the composition. The disclosure herein also includes use of radiation curing or use of a variety of preferred curatives (also referred to herein as crosslinking agents, curing agents), if other cure sites known in the art are used, other curatives that are capable of curing such alternative cure sites may also be used. For example, peroxide curing systems, such as those based on an organic peroxide, and related peroxide co-curatives may be used with halogenated functional cure site groups.

Exemplary cure site monomers are listed below and may be used in the curable fluoropolymer(s) or curable perfluoropolymer(s) described herein for use in the curable compositions, most of which are PAVE-based in structure and have a reactive site. Although the polymers may vary, preferred structures are those having the following structure (A):

CF₂═CFO(CF₂CF(CF₃)O)ₘ(CF2)ₙ—X¹ (A)

wherein m is 0 or an integer from 1 to 5, n is an integer from 1 to 5 and X′ is a nitrogen-containing group, such as nitrile or cyano. However, carboxyl groups, alkoxycarbonyl groups or halogenated end groups may also be used as X

The cure sites or functional groups X noted herein, e.g., nitrogen-containing groups, include the reactive sites for crosslinking when reacted with a curative. Compounds according to formula (A) may be used alone or in various, optional, combinations thereof. From a crosslinking perspective, it is preferred that the crosslinking functional group is a nitrogen-containing group, preferably a nitrile group.

Further examples of cure site monomers according to formula (A) include formulas (1) through (17) below:

CY₂═CY(CF₂)ₙ—X² (1)

wherein Y is H or F, n is an integer from 1 to about 8.

CF₂═CFCF₂R_{f2}—X² (2)

wherein R_{ƒ2} is (—CF₂)ₙ—, —(OCF₂)ₙ— and n is 0 or an integer from 1 to about 5.

CF₂═CFCF₂(OCF(CF₃)CF₂)ₘ(OCH₂CF₂CF₂)ₙ(OCH₂CF₂—X² (3)

wherein m is 0 or an integer from 1 to about 5 and n is 0 or an integer of from 1 to about 5.

CF₂═CFCF₂(OCH₂CF₂CF₂)ₘ(OCF(CF₃)CF₂)ₙOCF(CF₂)—X² (4)

wherein m is 0 or an integer from 1 to about 5, and n is 0 or an integer of from 1 to about 5.

CF₂═CF(OCF₂CF(CF₃))ₘO(CF2)ₙ—X² (5)

wherein m is 0 or an integer from 1 to about 5, and n is an integer of from 1 to about 8.

CF₂═CF(OCF₂CF(CF₃))ₘ—X² (6)

wherein m is an integer from 1 to about 5.

CF₂═CFOCF₂(CF(CF₃)OCF₂)ₙCF(—X²)CF₃ (7)

wherein n is an integer from 1 to about 4.

CF₂═CFO(CF₂)ₙOCF(CF₃)—X² (8)

wherein n is an integer of from 2 to about 5.

CF₂═CFO(CF₂)ₙ—(C₆H₄)—X² (9)

wherein n is an integer from 1 to about 6.

CF₂═CF(OCF₂CF(CF₃))ₙOCF₂CF(CF₃)—X² (10)

wherein n is an integer from 1 to about 2.

CH2═CFCF₂O(CF(CF₃)CF₂O)ₙCF(CF₃)—X² (11)

wherein n is 0 or an integer from 1 to about 5.

CF₂═CFO(CF₂CF(CF₃)O)ₘ(CF₂)ₙ═X2 (12)

wherein m is 0 or an integer from 1 to about 4 and n is an integer of 1 to about 5.

CH₂═CFCF₂OCF(CF₃)OCF(CF₃)—X² (13)

CH2═CFCF₂OCH₂CF₂—X² (14)

CF₂═CFO(CF₂CF(CF₃)O)ₘCF₂CF(CF₃)—X^{2 (}15)

wherein m is an integer greater than 0

CF₂═CFOCF(CF₃)CF₂O(CF₂)ₙ—X² (16)

wherein n is an integer that is at least 1; and

CF₂═CFOCF2OCF₂CF(CF₃))OCF₂—X² (17)

wherein X² can be a monomer reactive site such as a halogen or alkylated halogen group (I or Br, CH₂I and similar alkylated or alkoxylated reactive halogen groups and the like). Such cure site monomers may be at least partially fluorinated for use with curable fluoropolymers but are preferably perfluorinated along the portion of the backbone of the cure site monomer that lies in the polymer backbone chain when polymerized for use in curable perfluoropolymers.

Curable fluoropolymers that are non-perfluorinated fluoropolymers may also be used in the invention for us in making articles by additive manufacturing from fluoroelastomers. Such fluoropolymers (FKM) are materials classified by the Standard Rubber Nomenclature definitions provided by ASTM International in ASTM D1418-10a. Standard FKM polymers in accordance with such elastomer nomenclature typically have at least two monomers, one of which is fluorinated, and preferably all of which are fluorinated to some degree, with at least one cure site monomer for use in vulcanization. The at least two monomers preferably include vinylidene fluoride and hexafluoropropylene or a similar fluorinated olefin, but may include a variety of other monomers as well. The fluoroelastomer composition may also include at least one curing agent that is capable of undergoing a crosslinking reaction with a functional group in the cure site monomer(s) of the fluoroelastomer.

Such cure site monomer(s) may include a cure site monomer which is peroxide curable, and which may which includes a functional group comprising a halogenated material, such as Br or I in the cure site functional group. Such cure site monomers have a reactive functional group to permit cross-linking. While at least two of the monomers in an FKM are preferably hexafluoropropylene (HFP) and vinylidene fluoride (VF2), other typical monomers may be used in addition to these two for forming a variety of fluoropolymers known in the art.

The curable fluoropolymer may be radiation crosslinkable, but is preferably crosslinkable (curable) through a cure system wherein a curing agent(s) is/are added that is/are capable of reacting with a functional group in the cure site monomer for form an elastomeric material. For some curing systems, co-curing agents that work with the curing agent, or a second curing agent may be used. Optionally cure accelerator(s) may be employed as well. The compositions suitable for use in additive manufacturing herein may have a single curable fluoropolymer or a combination of at least two curable fluoropolymers, in the form of, for example, a polymer blend, grafted composition or alloy, depending on desired end properties.

The terms “uncured” or “curable,” refer to fluorine-containing polymers for use in compositions herein, which have not yet been subjected to crosslinking reactions in any substantial degree such that the material is not yet sufficiently cured for the intended application.

The curable fluoropolymer for the compositions herein may optionally include additional such polymers in blend-like compositions or grafted and/or copolymerized compositions as noted above. Further, the polymer backbones may include a variety of cure site monomer(s) along the chain to provide one or more different functional groups for crosslinking. The compositions may also include curing agents and co-curing agents and/or accelerators to assist in the cross-linking reactions.

One or more curable fluoropolymer(s) and/or one or more curable perfluoropolymer(s) may be present in such compositions. Such polymers are themselves formed by polymerizing or co-polymerizing one or more fluorinated monomers. Various techniques known in the art (direct polymerization, emulsion polymerization and/or free radical initiated polymerization, latex polymerization, etc.) can be used to form such polymers.

An FKM fluoropolymer may be formed by polymerizing two or more monomers, preferably one of which is at least partially fluorinated. For example, HFP and VF2 may be combined with tetrafluoroethylene (TFE) or one or more perfluoroalkyl vinyl ethers (PAVE), or similar monomers along with at least one monomer which is a cure site monomer to permit curing, i.e., at least one fluoropolymeric cure site monomer. A fluoroelastomer composition as described herein may include any suitable standard curable fluoroelastomeric fluoropolymer(s) (FKM) capable of being cured to form a fluoroelastomer as well as one or more other curing agents as described herein.

Examples of suitable curable FKM fluoropolymers include those sold under the trade name Tecnoflon® PL958 and Tecnoflon®959 available from Solvay Solexis, S.p.A., Italy or other similar fluoropolymers. Preferably, the curable fluoropolymers used herein have suitable physical properties, but also have a rheology and viscosity that when employed in the applications herein and introduced into an additive manufacturing process, they can be extruded as filament for use, for example, in FFF or FDM or fed as a composition in gum form in pieces to a ram material extruder in the ram device. Other suppliers of such materials include Daikin Industries, Japan; Asahi Glass Company, Japan; 3M Corporation, Minnesota; S. V. Lebedev Synthetic Rubber Research Institute, Russia (VNIISK); and E.I. DuPont de Nemours & Company, Inc., Delaware, among others. Such FKM polymers are not fully fluorinated on the backbone of the polymer.

According to the invention one or more curing agents (also referred to herein as curatives) in a curing system are used. Suitable curatives include bisphenyl-based curatives, nitrile curatives and peroxide curatives and co-curatives, such as an organic peroxide and a co-curative. In the preferred embodiments herein with respect to FKMs, bisphenyl-based curatives cure through VF2 monomer groups preferably adjacent HFP monomers, and the peroxide-based curing system cures through reaction with a functional group on a cure site monomer in the curable fluoropolymer. Suitable nitrile curing systems as described above for FFKMs may also be used.

Preferred functional groups in the cure site monomers for reacting with peroxide curing systems include those having halogenated reactive groups, e.g., iodine or bromine. however, additional cure sites may be provided to the same or a different cure site monomer such as those that might enhance, e.g., a bisphenyl-based curing as well, for example those that have a nitrile group, i.e., a nitrogen-containing reactive group.

In yet further embodiments, exemplary cure site monomers include those listed above which have a PAVE-based structure and a reactive site, such as structures noted above as structure (A) and variations (1) to (17) above.

Fluoropolymers for use in the compositions herein may be synthesized using any known or to be developed polymerization technique for forming fluorine-containing curable fluoropolymers by polymerization, including, for example, emulsion polymerization, latex polymerization, chain-initiated polymerization, batch polymerization and others. Preferably, the polymerization is undertaken so that reactive cure sites are located on at least one terminal end of the polymer backbone and/or are depending from the main polymer backbone.

One possible method of making the polymers includes radical polymerization using an initiator such as those known in the art for polymerization of fluorine-containing elastomers (organic or inorganic peroxide and azo compounds). Typical initiators are persulfates, percarbonates, peresters and the like, with preferred initiators being include salts of persulfuric acid, oxidizing carbonates and esters, and ammonium persulfate, with the most preferred being ammonium persulfate (APS). These initiators may be used alone or with reducing agents, such as sulfites and sulfite salts.

Standard polymerization procedures known in the art may be used. The cure-site monomer may be added and copolymerized when preparing the fluorine-containing elastomer. In their uncured or curable state, the fluoroelastomer compositions useful may include dual cure systems, such as having two cure site monomers with active functional groups in combination with more than one type of curative, e.g., at least one bisphenyl-based curative and an organic peroxide cure system, wherein the two curing systems are capable of undergoing a crosslinking reaction with one of the functional groups of the cure site monomers present on the fluoropolymer(s). In addition, if desired, additional curing agents or combinations of curing agents and co-curing agents may be employed particularly if additional cure site monomers are provided. Cure accelerators may also be used if desired. Halogen-containing functional groups as noted may above react with an organic peroxide curing agent and/or co-curing agent in the peroxide cure system.

When using a peroxide cure system, in an FKM fluoropolymer suitable curable fluoropolymers include polymers of VF2, HFP, and cure site monomers having a fluorinated structure with a peroxide-curable functional group, such as, for example, halogenated alkyl and other derivatives, and partially- or fully-halogenated hydrocarbon groups as noted above.

Curing agents for peroxide-based cure systems may be any organic peroxide curing agent and/or co-curing agent known or to be developed in the art, such as organic and dialkyl peroxides or other peroxides capable of generating radicals by heating and engaging in a cross-linking reaction with the functional group(s) of a cure site monomer on the fluoropolymer chain. Exemplary dialkylperoxides include di-tertbutyl-peroxide, 2,5-dimethyl-2,5-di(tertbutylperoxy)hexane; dicumyl peroxide; dibenzoyl peroxide; ditertbutyl perbenzoate; and di-[1,3-dimethyl-3-(tertbutylperoxy) butyl]-carbonate. Other peroxidic systems are described, for example, in U.S. Pat. Nos. 4,530,971 and 5,153,272, incorporated in relevant part with respect to such curing agents by reference.

Co-curatives for such peroxide curing agents typically include allyl compounds such as isocyanurates and similar compounds that are polyunsaturated and work with the peroxide curing agent to provide a useful cure, such as, for example, triallyl cyanurate (TAC); triallyl isocyanurate (TAIC); tri(methylallyl)isocyanurate (TMAIC); tris(diallylamine)-s-triazine; triallyl phosphite; N,N-diallyl acrylamide; hexaallyl phosphoramide; N,N,N′,N′-tetraalkyl tetraphthalamide; N,N,N′,N′-tetraallyl malonamide; trivinyl isocyanurate; 2,4,6-trivinyl methyltrisiloxane; and tri(5-norbornene-2-methylene)cyanurate. The most preferred is well known in the art is triallyl isocyanurate (TAIC) which is sold under trade names such as DIAK®, e.g., DIAK® #7, and TAIC®, including TAIC® DLC.

As a bisphenyl-based curing agent, bisphenyl-based materials and their derivatives may be used, and preferably a curative such as Bisphenol A, BOAP, bisaminothiophenols, bisamidoximes, and/or bisamidrazones is used. However, additional curatives such as, monoamidines and monoamidoximes, triazines, cyano-group-containing nitrile curatives, organometallic compounds and their hydroxides, curing agents containing amino groups such as diamines and diamine carbamates, such as N,N′-dicinnamylidene-1,6-hexanediamine, trimethylenediamine, cinnamylidene, trimethylenediamine, cinnamylidene ethylenediamine, and cinnamylidene hexamethylenediamine, hexamethylenediamine carbamate, bis(4-aminocyclohexly)methane carbamate, 1,3-diaminopropane monocarbamate, ethylenediamine carbamate, trimethylenediamine carbamate, and curatives as described in U.S. Pat. Nos. 7.521,510 B2, 7,247,749 B2 and 7,514,506 B2, each of which is incorporated herein in relevant part with respect to the listing of various curatives for cyano-group containing fluoropolymers and the like may be used in addition to the bisphenyl-based curative and the peroxide-based curing system if desired and/or if additional cure site monomers are provided that are curable by such agents.

Bisphenyl-based curatives and derivatives thereof, including BOAP, Bisphenol A, Bisphenol AF and their salts and derivatives, bisaminothiophenols, and parabenzoquinone dioxime (PBQD) may optionally also be used in combination with the peroxide curing system. In addition to these curatives, other bisphenyl-based curatives and their derivatives as described in U.S. Pat. Nos. 7,247,749 and 7,521,510, incorporated in relevant part with respect to such compounds may be used. Regardless of the type of bisphenyl-based curative used, it is most preferred that the compound has at least one and preferably two hydroxyl-containing functional reactive cure sites for reacting with cure site monomers as noted above.

Each of the at least one cure site monomers in each of the curable fluoropolymers or perfluoropolymers herein is preferably present in an amount of about 0.01 to about 10 mole percent of the curable fluoropolymer. The ratio of the other monomer(s) in the fluoropolymers may be varied within the scope of the art for achieving different properties in the end fluoropolymers or perfluoropolymers.

The collective amount of curative used in a composition with a curable fluoropolymer or perfluoropolymer is preferably about 0.01 to about 10 parts by weight per 100 parts by weight of the curable fluoropolymer(s) in the composition

Such curable fluoropolymer compositions and perfluoropolymer compositions may include various additives and fillers as are known for use in compounding fluorine-containing elastomers or new additives to be developed. Depending on the desired end properties, the fillers and additives in the composition aside from the curatives may be optionally added at amounts of about 0.5 parts to about 100 parts by weight based on the combined weight of the curable fluorine-containing polymers in the composition, and preferably about 10 parts to about 50 parts by weight based on the combined weight of the curable fluorine-containing polymers.

If desired, and although unnecessary, additives (other than the curatives noted above) may also be admixed such as by mixing or blending into the composition during compounding and prior to forming the extruded filament. Additives are optional and not required and, in some cases, may alter the viscosity properties such that conditions would have to be adjusted. However, if desired to for achieving certain elastomer performance properties, cure accelerators, curing co-agents, processing aids, plasticizers, fillers and modifiers such as silica, fluoropolymers (TFE and its melt-processible copolymers in micropowder form, pellet, fiber and nanopowder forms), fluorographite, silica, barium sulfate, carbon, carbon black, carbon fluoride, clay, talc, metallic fillers (titanium oxide, aluminum oxide, yttrium oxide, silicon oxide, zirconium oxide), metal carbides (silicon carbide, aluminum carbide), metallic nitrides (silicon nitride, aluminum nitride), other inorganic fillers (aluminum fluoride, carbon fluoride), colorants, organic dyes and/or pigments, such as azo, isoindolenone, quinacridone, diketopyrrolopyrrole, anthraquinone, and the like, imide fillers (such as polyimide, polyamide-imide and polyetherimide), ketone plastics (such as polyarylene ketones like PEEK, PEK and PEKK), polyarylates, polysulfones, polyethersulfones, polyphenylene sulfides, polyoxybenzoate, and the like may be used in amounts known in the art and/or which may be varied for different properties. All of the fillers herein may be used alone or in combinations of two or more such fillers and additives.

Preferably, any optional fillers are used in the amounts noted above and are less than about 100 parts per hundred parts of the combined curable fluoro- or perfluoropolymers in the composition. Desired curing times and temperatures that can be used to evaluate a heating curve for additive manufacturing may be developed based on the polymer composition prepared which should guide the selection for printing of properties that allow the polymer to be in the desired position D on the filament heating curve as discussed further below.

In preferred embodiments herein, the curable fluoropolymers and perfluoropolymers used herein may preferably have a Mooney viscosity (ML 1+10@121° C.) of about 10 to about 160. They may include a variety of plasticizers suitable for use in such polymers, which are known or to be developed in the art, to adjust the Mooney viscosity of the curable fluoropolymer or perfluoropolymer, or compound(s) thereof, to be used in printing. It is also acceptable to select a curable fluoropolymer and/or a curable perfluoropolymer that has a somewhat lower Mooney viscosity (ML 1+10@121° C.) of about 20 to about 45, preferably about 20 to about 40 or about 20 to about 30, which may or may not include optional plasticizers. Using curable fluorine-containing elastomer(s) or elastomer compound(s) having a Mooney viscosity in the ranges noted herein alone and/or in combination with a suitable plasticizer(s) can improve the ability to print such materials in the apparatus and methods herein with respect to providing easier printability, reducing shrinkage, providing sufficient available print time to avoid scorching or blistering while reducing overall print time, and increasing interlayer adhesion. It is also possible to use blends of curable fluoropolymer(s) and/or perfluoropolymer(s) of varying Mooney viscosities, with or without use of plasticizer(s), wherein such blends may be modified for desired print characteristics for a given curable fluoropolymer and/or perfluoropolymer material or compound using the methods and apparatus herein.

The invention in embodiments herein further requires providing an additive manufacturing printer having a drive mechanism and a printer nozzle. Such additive manufacturing printers are commercially available for purchase, including from, e.g., under the names Ultimaker, available from Ultimaker BV in the Netherlands, Monoprice Maker, available from Monoprice in Brea, California, and Creality3D Ender-5 Pro 3D Printer, available from Creality3d.shop. However, it should be understood that any such additive manufacturing printer that is capable of printing an elastomer article based on the disclosure herein may be used. Preferably such a printer would have one or more of the preferred features of the apparatus including the improvements described herein, or could be made directly by a manufacturer with alternative features provided it is capable of extruding a fluorine-containing curable fluoropolymer, partially, substantially or completely fluorinated so that a three-dimensional article comprising a fluoroelastomer or a perfluoroelastomer.

During one embodiment herein of a method for additive printing a fluorine-containing elastomer article, a filament having a curable fluoropolymer composition is fed to the apparatus, preferably after the filament enters the heated printhead including print nozzle and more preferably as the filament exits the nozzle, heat is applied to the filament to form a heated filament. In other embodiments of a method herein, using a ram material extruder, curable perfluoropolymer enters directly into the ram device and need not be in filament form. However, it may be heated within the ram device either in the barrel of the device and/or in the nozzle end of the device. While heat may be applied at any step in the process, (e.g., curable polymer composition feedstock may be heated prior to introduction to a ram material extruder ram device, including its printer nozzle or a heated filament may be pre-heated when entering the print drive mechanism, within the print drive mechanism, within the nozzle in the printhead or within the nozzle portion extending from the printhead to the nozzle outlet so that the heated filament is sufficiently hot to extrude the filament through the outlet of the nozzle), it is preferred that the curable fluoropolymer composition feedstock or filament is heated only so as to be flowable and not so hot as to initiate curing or to minimize any curing to avoid substantial curing prior to printing of a layer or layers. Preferably the curable fluoropolymer composition feedstock is heated within a ram material extruder ram device, including in its nozzle or a filament is heated within the printhead and enters and travels through the nozzle and out the nozzle outlet as a heated filament.

In one embodiment herein, in a preferred example thereof, the filament at the roller prior to entering the path through the printer to the nozzle is cooled to stiffen filament and help prevent possibilities of buckling. Any suitable chilling or cooling method and apparatus may be used for this purpose and such mechanisms are known in the art, and a chilling or cooling apparatus may be incorporated into any embodiment described herein as described in further detail below. Further, if using an apparatus where the curable fluoropolymer composition is fed directly to the ram material extruder, pre-cooling or chilling are not necessary. However, the fluoropolymer may be pre-chilled, if desired.

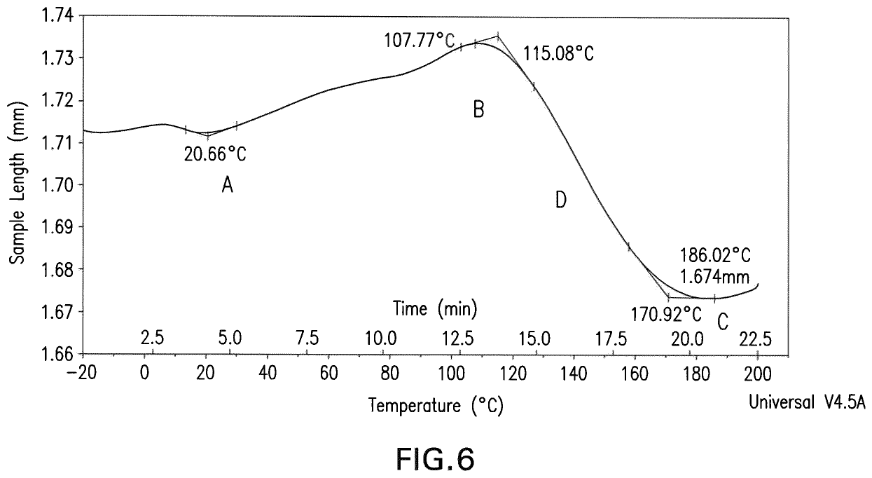

With reference to FIG. 6, showing a representative heat curve, the impact on filament width is shown as temperature increases for a representative curable perfluoropolymer. As the heat increases, filament thickness changes and gets wider (thicker) as the filament moves from a more ambient temperature (position A) to a level at which the curing (i.e., crosslinking) reaction begins (position B). As curing progresses and the temperature increases, the filament gets more attenuated and thinner in diameter hitting its thinnest level in position C where substantial curing has occurred. Based on the applicants' experimentation, it was determined that for processing in an additive manufacturing apparatus in various embodiments herein, curing of the material should either be avoided or be less than about 25% of curing to provide sufficient strength to the material, but should not progress so as to be too substantial that the curing would inhibit the ability to flow the curable material, extrude it through the nozzle and allow for continued curing while making layer-by-layer deposition of the elastomer article. Position D was viewed as the ideal range in which to extrude the curable perfluoropolymer through the nozzle. Thus, it was also determined that the majority of commercial printers, which are designed for high-temperature melting, are not all suitable for use in additive manufacturing to form fluoro- or perfluoroelastomer articles. It is thus preferred to use an additive manufacturing apparatus that is capable of operating below 200° C., more preferably below about 250° C., more preferably below about 200° C., and further, more preferably at or below 160° C.

In using such an additive printer apparatus with a perfluoropolymer filament, it is further preferred that a curable perfluoropolymer be heated as an extruded filament in the process at a temperature that is prior to initiation of curing, or to the extent some curing occurs, it is minimized to a degree greater than 0 to about 25% of curing during printing. Similarly, it is preferred that when introducing a curable composition having a fluoropolymer or perfluoropolymer in a printing apparatus including a ram material extruder that the extruded composition leaving the nozzle also be extruded at a temperature that is prior to initiation of curing, or to the extent some curing occurs, it is minimized to a degree greater than 0 to about 25%.

Evaluation of the cure characteristics of the curable fluoro- or perfluoropolymer may be made by RPA using the test method ASTM D2084 and then the temperature of the heated filament or extruded curable fluoropolymer composition is preferably kept to a temperature that is below a temperature associated with the time T2 on the curve using RPA. Any suitable RPA may be used for this purpose, including the commercial example as noted above. In some embodiments, depending on the curable polymer used, the filament may be heated to a temperature of about 20° C. to about 250° C., or about 70° C. to about 250° C. In other embodiments, the filament may be heated to a temperature of about 100° C. to about 250° C., preferably about 105° C. to about 200° C. and most preferably about 110° C. to about 160° C.

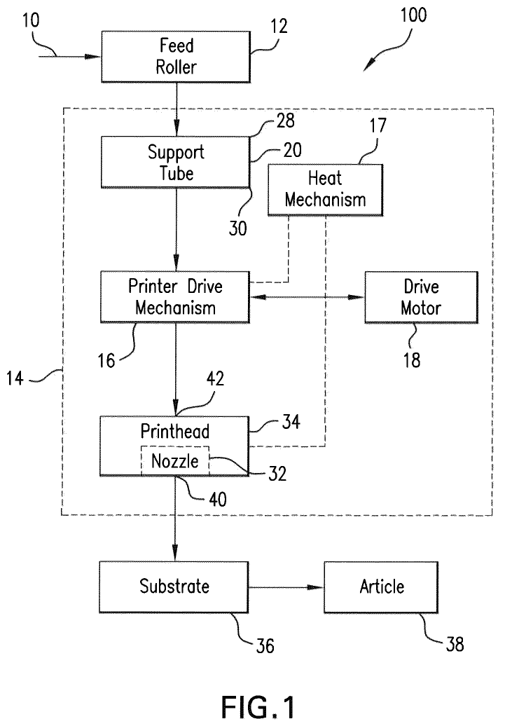

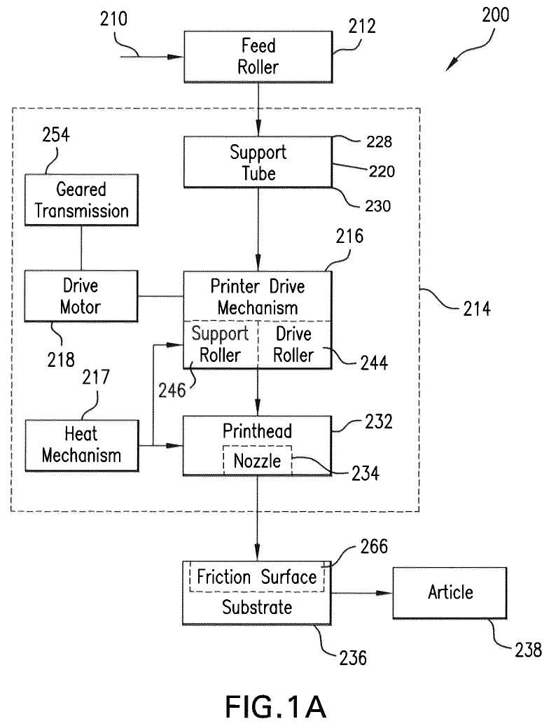

With reference to FIG. 1 a schematic flowchart is provided that is representative of a general additive manufacturing apparatus for use in one embodiment herein, referred to herein generally as embodiment 100, an extruded filament 10 may be delivered in roll form from a feed roller 12. The feed roller can be any standard feed roller used for delivery of extruded polymeric filament.

The filament, which may be cooled at initial introduction, is fed into an additive manufacturing printer 14 through the printer drive mechanism 16 which is preferably operated by a motor 18. In the preferred embodiment shown, a support tube 20 extends between the printer mechanism between the drive rollers and the inlet 42 of the nozzle 36 in the printhead 34.

The support tube 20 may have a variety of shapes in transverse cross-section, such as circular, elliptical, oval, egg-shaped, square, triangular, polygonal and the like. Preferably. the support tube has some internally curved surfaces from its cross-sectional shape for ease of travel of the filament within the tube, such as a circular cross-sectional shape. The tube is formed of a longitudinally extending tubular wall 22 that has an exterior surface and an interior surface 24 that defines a longitudinally extending passage 26. The support tube extends from a first end 28 to a second end 30. Filament exits the additive manufacturing printer 14 and enters the printhead 32 including nozzle 34. In leaving the nozzle 34, the extruded filament being consistently extruded through the nozzle outlet 40 deposits the extruded filament 10 onto a substrate 36 and continues to move the printhead by a standard additive manufacturing computer assisted control (not shown) as are known in the art to form a layer-by-layer application of the material and form the elastomer article 38.

The second end 30 of the support tube is preferably positioned proximate (which herein is intended to mean within its scope, near, close to, in the general area of, juxtaposed or touching) an inlet to a printer nozzle for allowing for fluid (flowable) communication between the support tube at its second end and the printhead. The closer the tube comes from a practical standpoint, the more support the tube may give to the filament without encountering filament buckling. However, the actual closeness of the second end of the support tube to the inlet of the printhead and nozzle will be impacted on how close the design of the specific apparatus used allows the second end of the support to reach.

Successive layers of the heated filament exiting an outlet 40 of the nozzle 32 are printed onto a substrate 36 using the additive manufacturing printer 14 to form the fluorine-containing elastomer article 38.

The curable fluoropolymer and perfluoropolymer filaments provided to the additive manufacturing printer are preferably formed by extruding the curable fluoropolymer composition. Such extruders are known in the art and are used for forming “rope” of fluoropolymer for use in forming objects such as O-rings by compression molding. Such extruders can be used for preparing the extruded filament for use in the additive manufacturing process and are well known in the art.

Heat may be applied to some degree, at any time during the process, including prior to introducing the filament to the tube, for controlled curing and flowability, allowing the filament to flow through the process and out the nozzle while avoiding excessive or premature curing. Preferably application of heat, however, occurs within the printhead and as the filament is entering the nozzle to allow for extruded flow through the nozzle and outlet thereof. The filament may have a range of viscosities as noted above, provided it flows through the nozzle and curing is controlled.

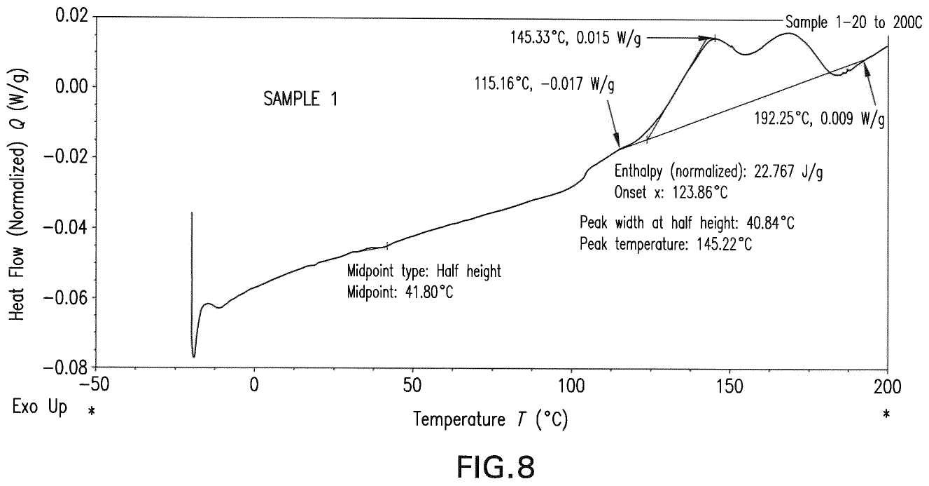

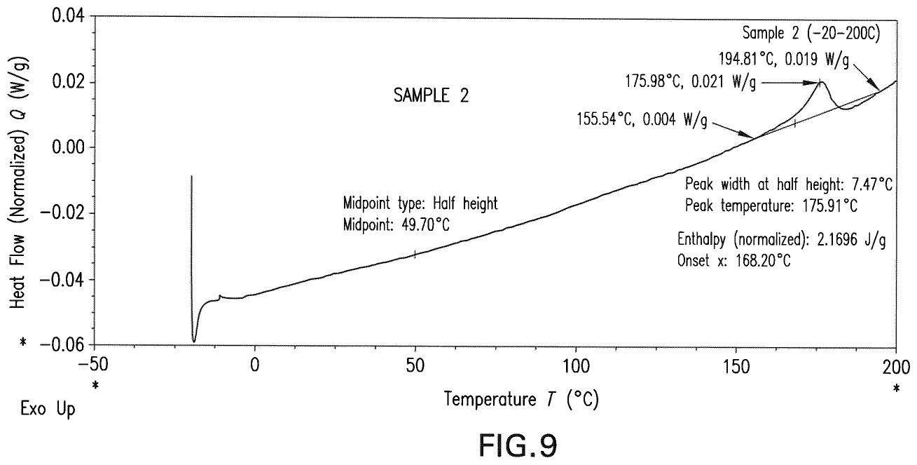

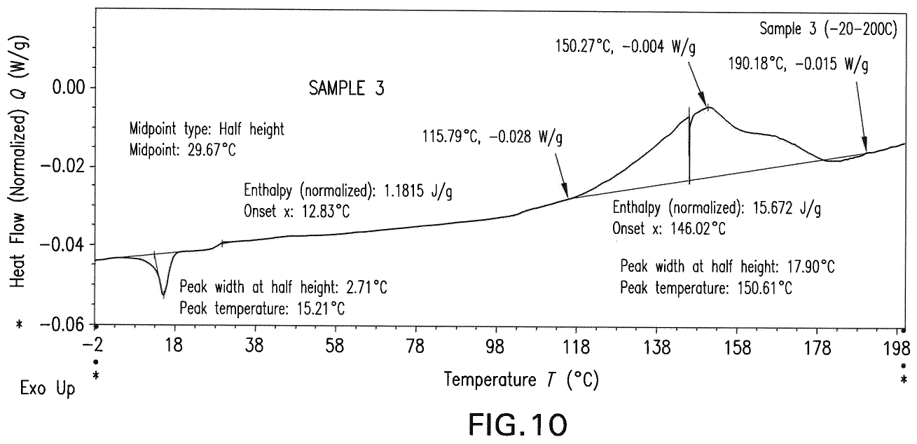

The Figures illustrate this as discussed above where the position D is the ideal processing temperature range for extrusion through the nozzle. For various polymers where the temperatures for curing can vary, the temperature may be adjusted to accommodate the curing cycle of that polymer as shown in the preferred area of the curing curve in the representative curve in FIG. 6, and in the Example curves shown in FIGS. 8-10 related to Examples herein. The curable fluoro- or perfluoropolymer, or compound thereof, is preferably cured in and after the nozzle outlet to a degree of about 10% to about 90% as the article is formed and finalized, including any post-curing thereof.

The filament may be heated through any suitable heat mechanism 17 or heating device including an external heater, a heated fan or an optional heating device in the additive manufacturing printer, preferably a heating element is located within the printer drive mechanism and/or the print head.

The apparatus in one embodiment herein is described with reference to FIG. 1A in a schematic flowchart form. This embodiment is referred to generally herein as embodiment 200 and like numbers indicate common elements in all embodiments. As shown, a curable fluorine-containing polymer filament is fed to the three-dimensional additive manufacturing apparatus 214 from a feed roller 212 to a printer drive mechanism 216 in the apparatus 214 that includes a drive wheel (roller) 244 and a support wheel (roller) 246. As used herein “wheel” and “roller” may be used interchangeably to refer to feed devices shaped in a generally circular, oval or arcuate manner to drive printing function and move the filament through the print drive mechanism. The two wheels 244, 246 move consistently through the printer drive mechanism 216 driven by the drive motor 218 to support and provide friction to the curable fluorine-containing filament as it passes through the space 248 between the drive wheel 244 and the support wheel 246, which is defined by the desired contact gap for the filament thickness, prior to entering the first end 228 of the support tube 220.

In this embodiment, the apparatus may include the optional feature of having the first end 228 of the support tube 220 extend upwardly through the printer drive mechanism 216 between the support wheel 244 and the drive wheel 246 so that the support tube may further support the filament as is leaves the feed roller 212 and enters the printer drive mechanism to avoid buckling of filament at this point, particularly if any heat has already been applied, or from the heat of frictional contact of the filament and the apparatus after leaving the feed roller.

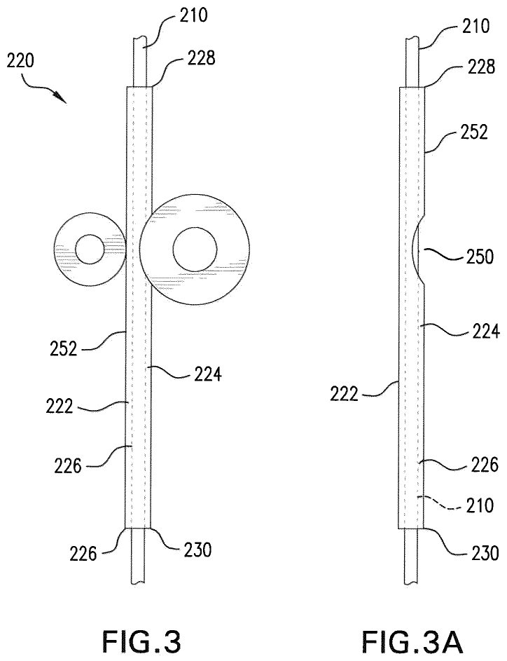

The support tube which may be used in such embodiment is shown in FIGS. 3 and 3A and differs from the support tube of embodiment 100 only with respect to the additional transverse opening discussed herein. Thus, the overall tube is otherwise the same.

The tube 220 is formed as a tubular wall 222 that has a longitudinally extending passage 226 defined by the interior surface 224 of the support tube wall 222. As fluorine-containing curable polymers that form elastomers are being fed in an attempt to control when curing begins, the tube is preferably formed of a material that does not introduce unnecessary frictional contact along the entire path of the tube interior wall. Thus, the tube is preferably formed of a smooth material and preferably also a low friction material such as polytetrafluoroethylene (PTFE) or a moldable co-polymer of tetrafluoroethylene.

The support tube wall 222 also defines a side opening 250 that extends transversely through the support tube wall 222 from the interior surface 224 of the support tube wall 222 to the exterior surface 252 of the wall. The wall that defines and surrounds the opening 250 is contoured to the shape of the drive wheel 224. The filament 210 may be fed through the support tube so that while it is passing through a support tube that is preferably formed of a material that reduces friction in the process as noted above to avoid unnecessarily engaging curing too soon in the process. As the filament 210 passes through the passage 226 of the support tube 220, the transversely extending side opening 250 allows for controlled contact of the filament with the drive wheel 244 in the area of the side opening as the filament passes through the drive mechanism to keep the filament moving consistently and at a desired speed while minimizing the friction impact and supporting the filament using the support tube from above the printer drive mechanism (and from as close as the first end 228 of the support tube 220 can get to the feed roller 212) while maintaining a smooth filament introduction into the support tube thereby controlling the column height above the print drive mechanism and above the nozzle of the filament to allow for a smooth and controllable passage of a difficult-to-process elastomer such as a fluorine-containing elastomer through an additive manufacturing printer without sacrificing the important role of the printer drive roller in the printer drive mechanism in directing the filament into the printhead and controlling the speed of its approach.

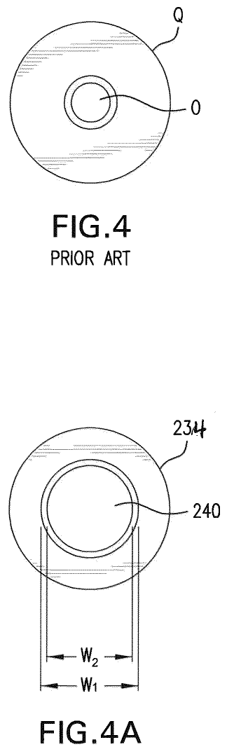

When forming fluorine-containing elastomer articles, such as seals, an inner diameter (e.g., w₂ of FIG. 6) of the printer nozzle outlet 240 may be sized to be approximately the same size as a longitudinal cross-sectional outer diameter of the intended seal to be formed. In one embodiment, herein, due to the filament temperature profile, as shown in illustrative form in FIG. 6, an improvement includes that, when processing curable fluorine-containing polymers in an additive manufacturing apparatus, it is noted that elastomeric materials of this nature (and other similar viscous thermoset elastomers) require more pressure in leaving the nozzle outlet than standard printed thermoplastic filaments do. As shown in FIG. 4, a prior art print nozzle may be somewhat smaller than what is needed to accommodate filaments formed of extruded curable fluorine-containing polymer(s) or other similar elastomer base polymers. Most standard additive manufacturing apparatuses are not designed to handle the required degree of pressure to allow for the more viscous material to pass through easily (particularly as some curing is initiated from the application of heat). A standard approach to increasing pressure on viscous thermoplastics is to heat them. However, too much heat on the curable fluorine-containing polymer(s) or similar uncured elastomer base polymer(s) can cause on-set curing, which can restrict or weaken the filament at the wrong moment and/or can cause buckling at the inlet 242 of the nozzle 234 or blockage of the nozzle.

Accordingly, in the embodiment of FIG. 1 or 1A, as shown with reference to FIGS. 4 and 4A, an outlet 240 of a nozzle 234 (or an outlet 40 in a nozzle 34) in preferred embodiments herein may be modified to be wider than the standard inner diameter (ID) of an outlet O of a nozzle Q of a standard prior art additive printer apparatus nozzle. The preferred outlet has an expanded inner diameter or width, w₂, measured transversely in the widest dimension of the outlet, and a correspondingly wider outer diameter or width w₁, so as to accommodate the maximum outer diameter of a heated fluorine-containing fluoropolymer filament at a stage in the heat curve (see FIG. 6 for example) in which the fluoropolymer is entering the preferred position D and wherein heat is controlled in the printer by a heating mechanism 217 in a manner that is the same as in embodiment 100. By using an outlet size that is approximately the same size or within a range of plus or minus about 0.1 mm to about 0.5 mm of the filament thickness of the filament based on its heat curve at the preferred processing temperature, the filament may extrude properly through the nozzle to allow for an uninterrupted extrusion, avoid blockage and prevent buckling at the entry of the printhead. In embodiments herein, the inner diameter may be at least about 0.2 mm, or about 0.2 to about 3.3 mm. In another embodiment, it may be about 0.4 mm to about 1.6 mm.

For example, as shown in FIG. 6, a filament formed of a curable perfluoropolymer composition in the preferred heating zone of position D has an outer diameter of about 0.2 mm to about 20 mm. Thus, the nozzle may be sized accordingly, e.g., it may be about 0.2 mm to about 20 mm, and preferably, in this particular example, it is about 1.0 mm to about 3.0 mm.

In preferred embodiments of embodiments 100 and 200, herein the additive manufacturing printer 14, 214 preferably includes a drive motor 18, 218 for operating the drive mechanism that is preferably a stepper motor. The motor preferably provides sufficient torque to overcome any friction between the filament and the additive manufacturing drive printer and its components while providing sufficient pressure to extrude the material through the additive manufacturing printer and out the exit of the nozzle without losing constant speed and while avoiding blockages or filament buckling.

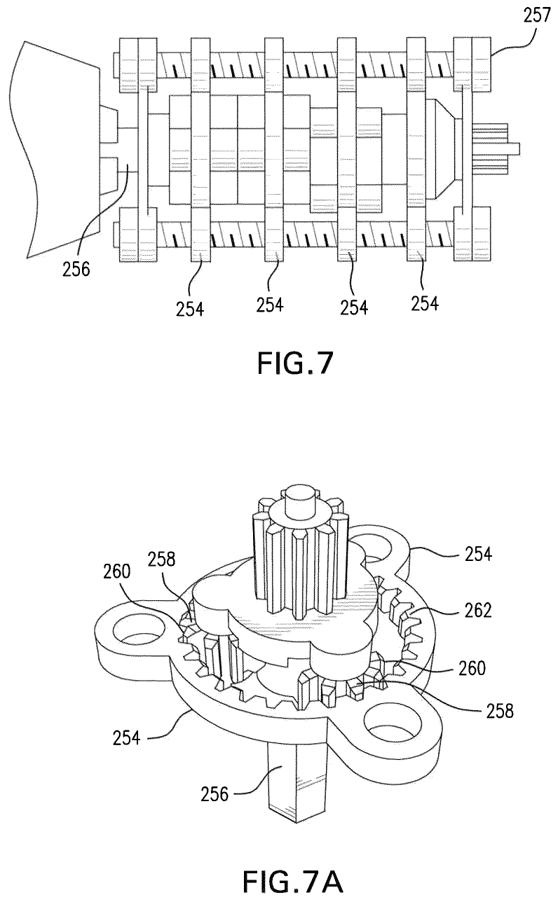

As most standard additive printers have stepper motors designed for less viscous materials that are easily extrudable, the drive motor even if a stepper motor is used, is likely to have insufficient torque for smooth movement of the filament and to require additional power for operation. Thus, the additive manufacturing printer should have a larger capacity stepper motor and/or be modified to achieve the required torque and power requirements for operation when printing elastomer materials that are more viscous and/or need to be maintained at a constant speed and thickness to achieve a printed elastomer article. One preferred modification herein is to provide a geared transmission 257 to an additive printer drive mechanism's stepper motor to increase the torque of the stepper motor. An example of a geared transmission may include one or more planetary gears 254. Such a geared transmission 257, including a planetary gear 254 is shown in FIGS. 7 and 7A. In FIG. 7A, a single planetary gear 254 is shown which is affixed to the drive shaft 256 of the stepper motor 218 as a geared transmission 257. A connecting series of smaller gears 258 having edge teeth 260 are rotationally positioned to interact with internally mating teeth 262. A series of such planetary gears 254 may be used in series in an interconnecting manner to adjust and enhance a standard drive motor torque of a commercial additive manufacturing printer. Table 1 below shows the increase in torque and other properties for a modified stepper motor using the configuration of FIG. 7 in comparison with the same motor prior to modification.

TABLE 1

| | Standard | | | |
|---|---|---|---|---|
| | Additive | | | |
| | Apparatus | | | |
| Features | Motor | | Modified Motor | |
| Motor Type | Bipolar Stepper | | Bipolar Stepper | |
| Step Angle | 1.8° | | 0.35° | |
| Holding Torque | 0.46 | Nm | 1.68 | Nm |
| Rated Current/Phase | 1.7 | A | 1.68 | A |
| Phase Resistance | 2.1 | ohms | 1.65 | ohms |
| Recommended Voltage | 9-42 | V | 12-24 | V |

| | | | |
|---|---|---|---|
| Inductance | 4 | mH | 3.2 mH + 20% |
| | | | (1 KHz) |

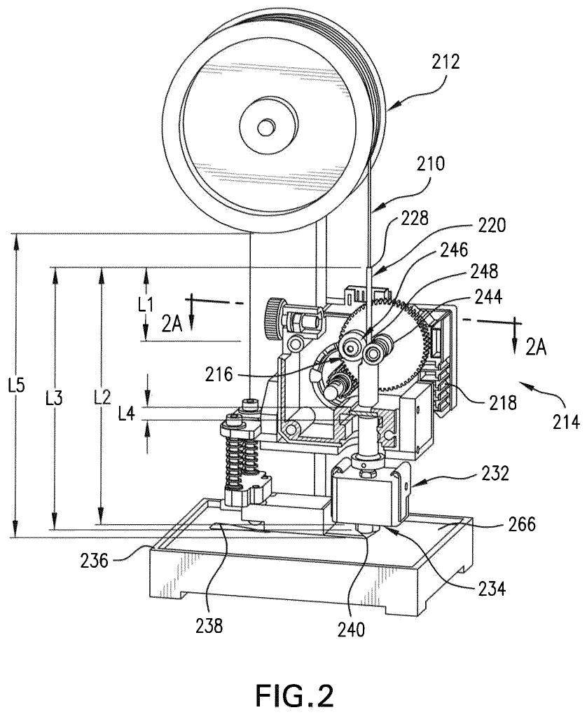

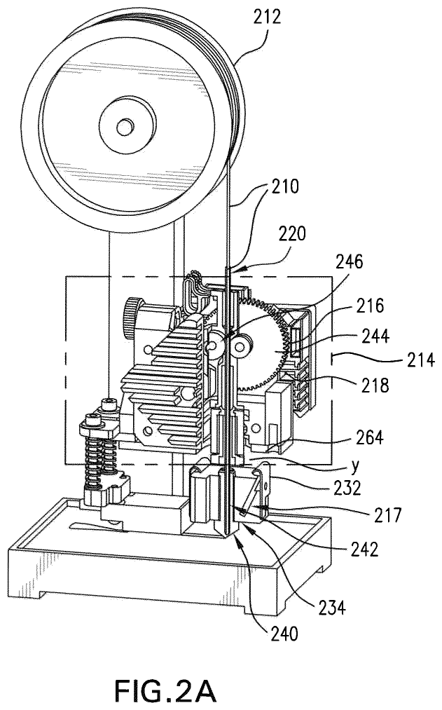

The invention further also includes an article formed by a heated filament comprising a curable fluoropolymer composition extruded through a nozzle of an additive manufacturing apparatus. The apparatus may include the features as set forth above and as shown in an assembled manner in FIG. 2. The additive manufacturing apparatus 14, 214 is in this embodiment may be, in preferred embodiments, a fused filament fabrication apparatus or a fused deposition apparatus for FFF or FDM devices.

Various curable fluorine-containing compositions may be used and formed into three-dimensional articles in an additive manufacturing composition herein and may include one or more of the curable fluorine-containing polymers, including fluoropolymers that are partially fluorinated (FKMs) and substantially or completely fluorinated perfluoropolymers (FFKMs) each having a functional group for reacting with a curative; and further include one or more curatives suitable for curing those polymers selected which are as described above that is/are capable of reacting with the respective functional group or groups on the cure site monomer(s) of the fluoropolymers selected. Preferred fluoropolymers and perfluoropolymers for additive manufacturing in the apparatus as described above have an uncured Mooney viscosity of about 10 to about 160 ML 1+10 at 121° C.

The invention further includes an additive manufacturing apparatus as noted above that is capable of forming a three-dimensional printed elastomer articles. The printer drive mechanism of the apparatuses herein may include in preferred embodiments a drive roller and a support roller as described above, and the apparatus may further include a support tube as described herein which is situated so as to extend beneath the printer drive mechanism, so that the drive roller is preferably positioned to contact the extruded filament fed into the tube within the printer drive mechanism. The support tube thus may extend from a lower surface such as lower surface 264 of the printer drive mechanism to an area Y proximate the inlet 242 of the nozzle 234 through the printhead 232 as shown in FIGS. 2 and 2A.

The support tube may have its first end 228 preferably positioned above the printer drive mechanism 216 and its second end 230 is preferably proximate to the inlet of the nozzle 234. Also, as described more fully above, the support tube 220 is preferably configured to support a filament of a curable fluorine-containing polymer passing through the first end 228 of the support tube and exiting through the second end 230 of the support tube, and may include a side opening as described above extending transversely through the wall of the tube from the interior surface to an exterior surface of the tube, for facilitating direct contact between the drive roller and filament passing through the longitudinal passage of the support tube. Also, as noted above, in one preferred embodiment, the first end 228 of the support tube 220 may be positioned closer to the feed roller to reduce column height so as to receive a curable polymer filament leaving the feed roller and avoiding buckling of the filament.

In a further embodiment, the substrate 236 may comprise a frictional surface to improve adhesion of non-tacky extruded curable polymer onto the substrate. As curable fluoropolymers include tetrafluoroethylene and are highly inert, creating a tacky or frictional finish or upper surface on the substrate 236 such as friction surface 266 may improve the results in forming the finished article. While interlayer adhesion can be improved by the cure process, initial adhesion to the substrate 236 is important to laying a strong first layer upon which to build the article that is stable and accepts the subsequent layers. Such a frictional surface may comprise, e.g., an adhesive, a roughened surface, a treatment that attracts or has a minimal amount of bonding agent, or a PTFE-containing surface that may somewhat interact with the first print layer. Such substrates with frictional surfaces or surface treatments may be used in any of the embodiments herein.

In another embodiment herein, for forming various shaped articles, a support structure such as a removable or permanent fixture may be used. Such structures are discussed in detail hereinbelow.

As shown in FIG. 2, the support tube has a length l₁ above the print drive mechanism as measured in the longitudinal direction, and also extends beneath the print drive mechanism having a length from the bottom surface 264 of the print drive mechanism to the top area Y proximate the printhead 232 having the nozzle inlet 242 that is l₄. The distance from the substrate to the bottom of the feed roller 212 represents the entire length of the filament path from roller to extrudate contact with the substrate and is represented as l₅. The distance from the first end of the support tube to the location in the printhead where the filament enters the nozzle is l₂ and the length measured from the top of the support tube to the nozzle outlet is l₃. The difference between l₃ and l₂ represents the nozzle height. The difference between l₃ and the combined lengths of l₁ and l₄ is the height of the print drive mechanism. The height of the upwardly extending tube is preferably selected to closely match the distance from the drive gear in the geared transmission to the heat break, i.e., the area where the filament enters the heated printhead. The specific distance is selected by the sizing of the drive gears in the geared transmission, the motor, and related transmission packaging. While lesser distances are preferred, the use of the upwardly extending tube provides sufficient support for the filament to perform in and successfully move through the three-dimensional printing apparatus.

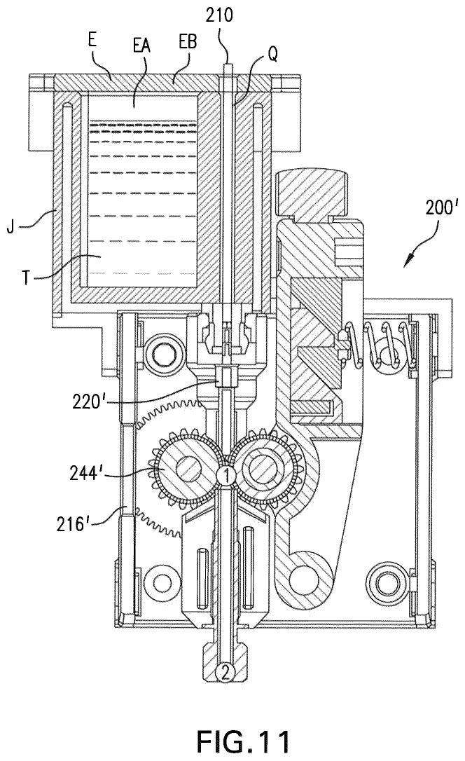

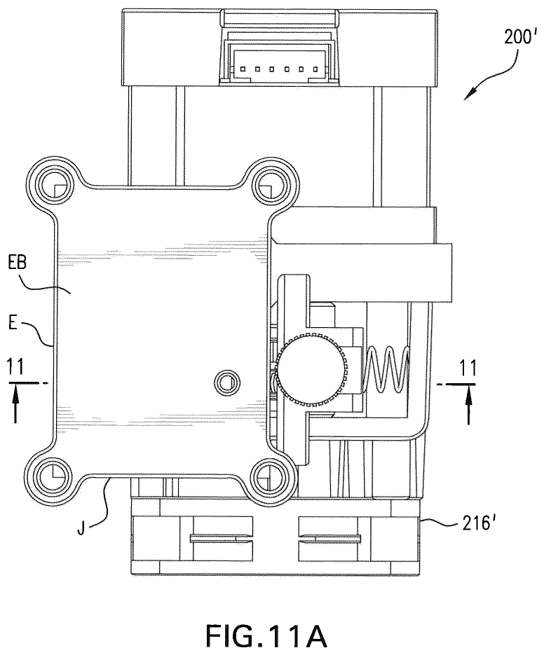

As noted above, in the various embodiments described, a cooling or chilling apparatus may be provided at the outset of the process to achieve various benefits in additive manufacturing of curable fluorine-containing polymeric materials. For example, a chilling or cooling apparatus E in the form of a pre-cooler is shown in FIG. 11 may be provided. The pre-cooler E is shown as a multi-walled vessel J mounted above a printer according to embodiment 200, but with a somewhat modified drive mechanism 216′ for use within an additive printer such a printer 214′ in an embodiment 200′ herein. Such drive mechanisms can be part of a filament extruder as well. The filament 210′ shown in FIG. 11 is provided to a support tube 220′ through a bore Q defined by the multi-walled vessel J. As shown the bore Q is preferably round in transverse cross-section, but may be modified in shape for operational or design purposes. The bore allows for smooth passage to the support tube while also allowing the filament 220′ to pass through the cooled wall and bore Q in the pre-cooler E. As the filament passes, the filament temperature approaches the temperature of a coolant such as coolant within a cooling chamber EA also defined by and within the structure of the multi-walled vessel J. A removable cover EB may be provided if desired for cleaning, filling and/or replacement of coolant T. While the pre-cooler is shown with an apparatus additive printer like that of embodiments 200, 200′ herein, a pre-cooler may also be used with any embodiment herein.

Coolants used may vary, including mixtures of calcium chloride hexahydrate and ice to achieve a temperature of about −40° C. However, dry ice, regular ice, and others may be used depending on the temperature reduction and desired end conditions. The pre-cooler E may be filled intermittently, such as by optional cover EB, or continuously such as by introducing coolant through a continuous exchange feed, such as running coolant through an exchanger designed for cooling. Preferably with fluorinated materials as described herein the pre-cooler is continuously filled and kept at a preferred low temperature of about −40° C., but the temperatures may be varied according to the material selected.

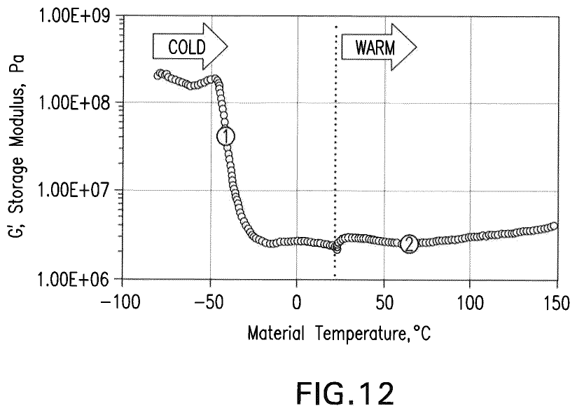

Cooling and nozzle extrusion temperatures may be derived and chosen using material properties as described herein as measured using analytical tools, such as a dynamic mechanical analysis (DMA). With reference to FIG. 12, the storage modulus may be measured across a range of temperatures, e.g., from coolant temperatures to curing temperatures of the curable fluoropolymer compositions or curable perfluoropolymer compositions used and/or in a filament. In some instances, multiple DMA testing and analyses may be undertaken using varying specimens and the end results normalized by matching the DMA data at overlapping temperatures. FIG. 12 is an exemplary profile showing a range of storage modulus values that is derived from two DMA tests in which the first test spanned from −80° C. to 20° C., and the second test spanned from 20° C. to 140° C. The storage modulus data at 20° C. was used to “match” or scale the two data sets such that the relative storage modulus as a function of temperature is characterized sufficiently for use.

The cooling temperature and nozzle extrusion temperature may be selected to determine the relative storage modulus during the additive manufacturing printing process. For example, point 1 shown on exemplary FIG. 12 corresponds to a −40° C. temperature and a 50 MPa storage modulus for the filament evaluated at a point where the filament is being driven through the drive and support wheels, 244′, 246′, such as the drive gears shown in FIG. 11, also at a corresponding point 1 in FIG. 11. The temperature at a point 2 on FIG. 11 which is at the hot end of the drive mechanism when entering the nozzle for printing is then selected to be 60° C. at a point 2 where the storage modulus is 2 MPa as indicated by corresponding point 2 in FIG. 12.

Other advantages of the apparatus and process when incorporating a pre-cooler E, can be identified with reference to the “free column length,” of the support tube, which is defined generally herein as the distance from a centerline point within the drive rollers or gears to the entrance below the rollers/gears into the lower portion of support tube extending beneath the drive mechanism. In the example apparatus shown in FIG. 11, which is prepared using a commercial Hemera® extruder, commercially available from E3D Online, Oxfordshire, UK that is equipped with dual drive gears, and a controlled minimal clearance, the free column length is 5 mm and the filament diameter is 1.75 mm. The extruder having the drive mechanism as noted was mounted on a mounting bracket for printing use. With respect to the free column length, considering the driven filament as a simply supported column, the critical buckling force (F_{cr}) of the filament is estimated as:

$${F}_{{cr}^{=}} \frac{µ EI {π}^{2}}{{L}^{2}} \qquad ( I )$$

wherein, μ is the constraint factor, E is Young's Modulus, I is the moment of inertia of the cross-sectional area and L is the free column length. With the use of a pre-cooler, such as pre-cooler E of FIG. 11, the critical buckling force F_{cr} is increased in this exemplary embodiment from 0.36 N to 9.1 N, corresponding to an increase in critical buckling pressure, P_{cr} (maximum pressure), which is calculated as

$${F}_{c r} / A \qquad ( II )$$

wherein A is the cross-sectional area of the filament, of 0.15 MPa to 3.8 MPa.

An increase in the maximum pressure as noted above greatly increases the achievable draw-down of the filament in the process and apparatus, thereby allowing use of a reduced nozzle orifice diameter. The achievable draw-down (meaning reduction in filament diameter from entry into the nozzle through exit of the nozzle, can be estimated by considering the filament extrusion as a solid material undergoing elastic-plastic deformation. The maximum draw ratio, B, is then estimated as Euler's Number, e, which is approximately 2.71828, raised to the ratio of the maximum pressure to the storage modulus, k, of the material being extruded. That is

$$B = {e}^{P c r / k} \qquad ( III )$$

For the material properties and filament described, the use of the pre-cooler for curable fluoro- and perfluoropolymer compositions printed herein in this exemplary embodiment is able to increase the maximum draw ratio from 1.1 without a pre-cooler to 6.6 with the pre-cooler. The minimum orifice diameter may then be estimated as the filament diameter divided by the square root of the draw ratio. The analysis suggests that use of the pre-cooler herein allows the nozzle orifice to decrease from 1.69 mm to 0.68 mm. This principle and design may be employed with the curable fluoropolymer compositions and curable perfluoropolymer compositions and other materials where such benefits would be advantageous in additive manufacturing printing.

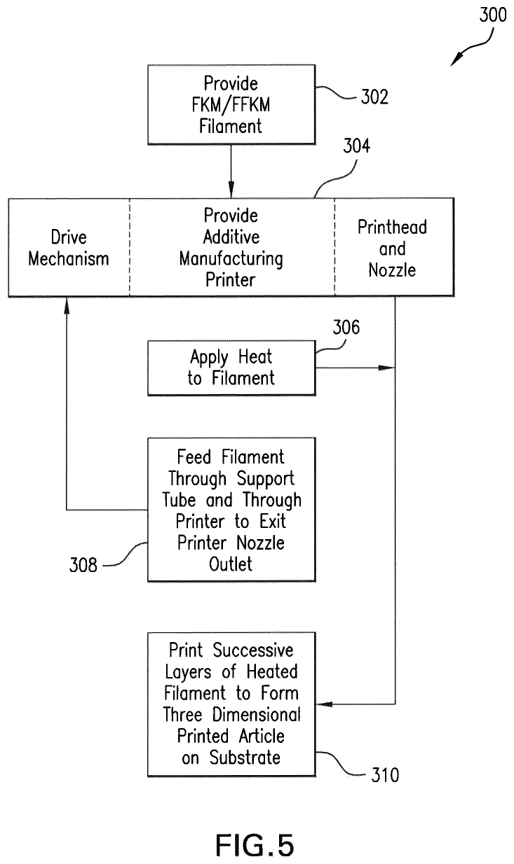

In one process herein, in an exemplary embodiment 300, as represented in FIG. 5, the method includes the step 302 of providing the curable polymer, such as the fluoropolymer or perfluoropolymer compositions noted above in extruded form (i.e., they may be pre-compounded and extruded into an initial rope or filament). The method also includes the step 304 of providing the additive manufacturing printer according to any embodiments herein, which printer preferably includes a drive mechanism and a printhead and nozzle. Heat is applied in step 306 to the filament which may be done at various phases of the process, including at the feed stage, within the additive manufacturing printer drive mechanism, or in the printhead and/or nozzle. A further step 308 includes feeding the filament through a support tube and through the additive manufacturing printer so that it exits as an extrudate from the outlet of the printhead nozzle and onto a substrate. Successive layers may then be applied in step 310 upon the initially extruded layer on the substrate to form a three-dimensional, printed article on the substrate.

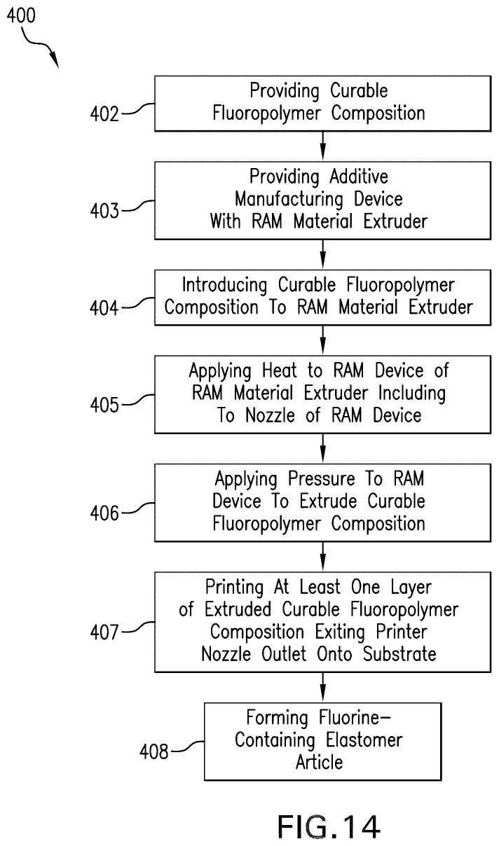

In a further embodiment herein, a method is provided for forming a fluorine-containing elastomer article. The article is represented generally in FIG. 14 as embodiment 400. In the method, a curable fluoropolymer composition is provided in step 402. The curable fluoropolymer composition may be any of the compositions noted above with respect to previous embodiments, and can include one or more fluoropolymer(s) that are at least partially fluorinated, or perfluorinated, i.e., a perfluoropolymer or combinations and blends thereof. Curative(s), additives and additional fluoro- or perfluoropolymers may be included as noted above in prior embodiments. In step 403, an additive manufacturing printer apparatus is provided that comprises a ram material extruder. The ram material extruder includes a ram device operable for extrusion under pressure and a printer nozzle. The additive manufacturing printer may be any of those noted previously or suitable for being configured to support and/or be in operable connection with the ram material extruder. Suitable such printers include, e.g., Creality3D Ender-5 Pro 3D Printer, available on-line from Creality3d.shop. The ram material extruder may be a suitable such device including various ARME-type printers, including ARME1, ARME2 and ARME3 designs or any variations or modifications thereof. The additive manufacturing printer apparatus should be capable of forming three-dimensional printed articles comprising a fluoroelastomer that is at least partially fluorinated, and may be perfluorinated in the manner of a perfluoroelastomer and various combinations, alloys and blends thereof. The apparatus should also be capable of printing articles such as component parts, including various types of articles noted above, including gaskets and seals.

In step 404, the method includes introducing the curable fluoropolymer composition for printing to the ram material extruder. The curable fluoropolymer composition may be provided in blended gum form or in a pre-shaped form such as a filament or other shape or may simply be cut into pieces of the gum. The composition may be introduced into ram device of the ram material extruder directly such that feeding the composition through a long processing path through support tubes and drive wheels can be avoided in such an embodiment.

The method may include, as with prior embodiments herein, analysis of the curable fluoropolymer composition chosen prior to operation to estimate its storage modulus using DMA or parallel plate rheometry to optimize the printing parameters for the curable fluoropolymer composition, evaluate the flow temperature and pressure to be applied as well as evaluate a desired nozzle tip.

Heat is applied in step 405 to the ram device of the ram material extruder, including in the printer nozzle of the ram material extruder. Heat may also be applied to the composition before adding it to the ram device. While unnecessary when using the ram material extruder, if desired, the composition may be chilled prior to introducing it to the device using a chiller as shown above in prior embodiments. However, such pre-cooling (while useful in the filament embodiments described previously) is wholly optional with this apparatus.

In embodiments herein, it is preferred that the additive manufacturing apparatus is capable of printing at lower temperatures than is required for thermoplastics, for example, at temperatures of less than about 250° C., or less than about 200° C., or even more preferably less than about 160° C. or less than about 100° C. or less than about 70° C., but is also in each instance also capable of printing at a temperature of at least about 20° C.

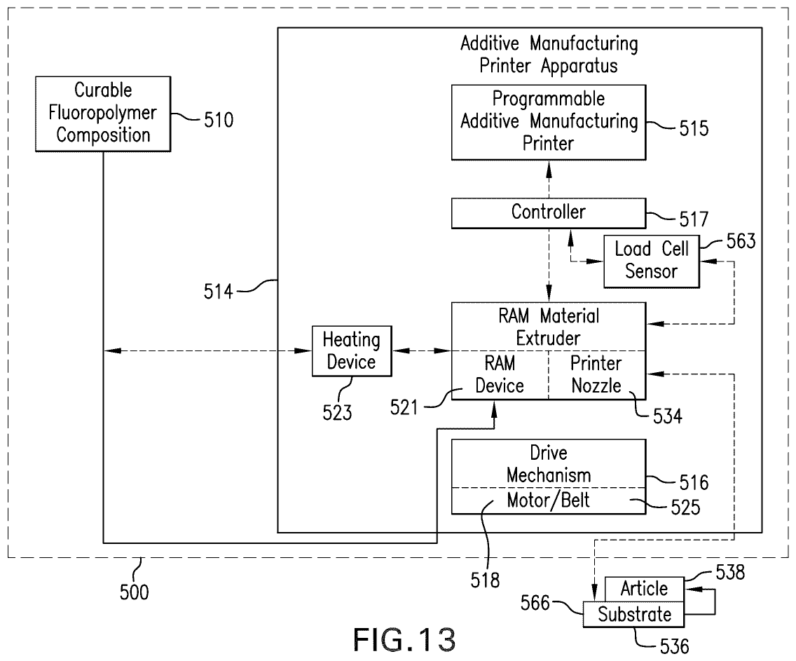

Pressure is applied in step 406 to the ram device for the purpose of extruding the curable fluoropolymer composition through the ram device and out the printer nozzle outlet, and preferably onto a substrate. Heating and pressure application can occur sequentially or wholly or partially simultaneously. Pre-pressurizing without heat application can facilitate proper loading of the curable fluoropolymer composition within the ram device prior to printing. In step 407, at least one layer of extruded curable fluoropolymer composition is printed using the additive manufacturing apparatus. The printing of the composition occurs as it exits the printer nozzle outlet onto a substrate to form a printed article 538 having a fluorine-containing elastomer. As the printing is completed, a fluorine-containing elastomer article 538 is formed in step 408 as shown with respect to FIGS. 13 and 14.

The invention also includes a system, referred to herein as embodiment 500, which includes a curable fluoropolymer composition 510 and an additive manufacturing printer apparatus 514 that is able to carry out the method 400. Such a system is shown schematically in FIG. 13. The additive manufacturing printer apparatus 514 may be used in the method 400 noted above and so will be described herein.

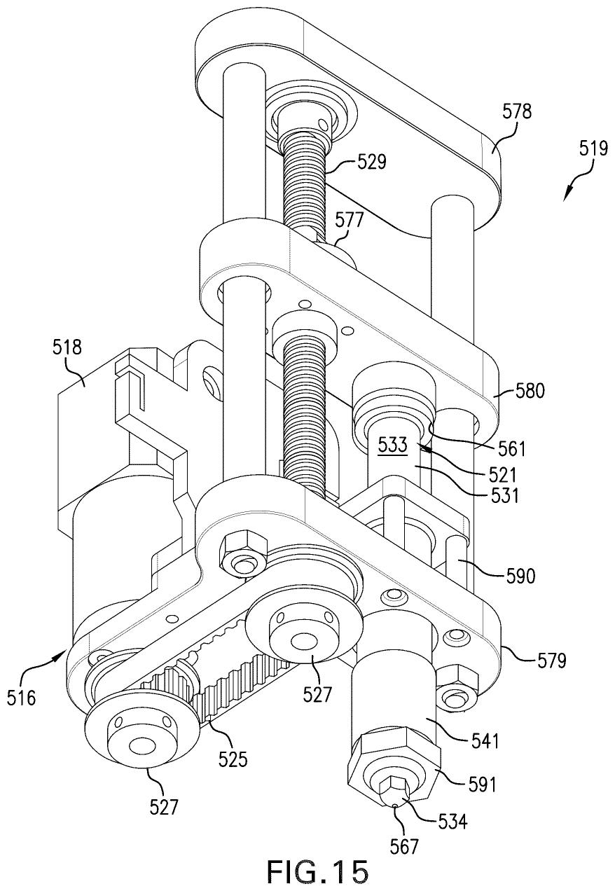

The additive manufacturing printer apparatus 514 may be any suitable printer as noted above and with respect to step 403 of method 400. The curable fluoropolymer composition 510 may be any suitable curable fluoropolymer compositions noted above for use in the additive manufacturing embodiments herein. The additive manufacturing printer apparatus 514, preferably includes a programmable additive manufacturing printer 515 incorporating a controller 517 and associated software for printing an article using software code as noted above. The additive manufacturing printer apparatus 514 also includes a ram material extruder 519, as best shown in FIGS. 15-19 that includes a ram device 521 and a printer nozzle 534. The ram material extruder 519 may be mounted using a mounting plate to the associated apparatus of the additive manufacturing printer apparatus 514 on a gantry or other similar mechanism known in the art.

The ram material extruder may be a commercial or custom-built ram material extruder apparatus, currently available or to be developed, capable of performing the extrusion step using the materials herein consistent with this specification. Suitable ram material extruder devices may be acquired commercially or custom built. A suitable source for such devices may be secured from the SHAP3D™ Industry University Cooperative Research Center, through the University of Massachusetts Lowell, One University Avenue, Lowell, MA by requesting instructions and a list of parts for building an ARME I, ARME 2 or ARME 3 device or requesting an assembled ARME 1 or ARME 2 or ARME 3 device. An ARME 1 device is as shown in FIGS. 15-19 and an ARME 2 device is similar in construction with the timing belt and wheels on an upper portion of the assembly and with two lead screws. The ARME 2 device is indicated when additional extrusion force is needed. It is preferred that at least one lead screw is incorporated in the ram material extruder, and also that two such lead screws may be used.

In one embodiment herein, printer apparatus 514 has a ram material extruder 519 wherein a lower platen 579 that supports the operable apparatus of the extruder 519. On a rear portion of the lower platen 579 is mounted a printer drive mechanism 516. In the preferred embodiment shown, the drive mechanism 516 may include a drive motor 518 and a timing belt 525 operable on two timing belt wheels 527. More wheels may be used if desired or a gear mechanism could be used. However, in the apparatus embodiment shown, the drive mechanism incorporates the timing belt and wheels as shown. The drive mechanism may be used in the method herein and operated to apply pressure to the ram device 521.

The drive mechanism motor operates the timing belt which rotates in communication with a lead screw 529 passing through the lower platen 579 and extending upward through the ram material extruder 519 passing through an opening in a middle platen 580 and terminating in an upper platen 578. The middle platen is movable in the z-direction (generally longitudinally) up and down so as to apply pressure to the ram device 521. As the lead screw 529 is rotated by the drive mechanism timing belt movement, the nut 577 facilitates rotation and supports the lead screw, allowing the platen 580 to move upwardly or downwardly. When the middle platen moves downwardly it depresses the top of the ram device 521 at the load cell 561 in contact with a piston 531 as described below.

Thus, the method may include operating the drive mechanism to apply pressure to the ram device. Suitable pressure to be applied to the ram device can range from about 0.5 MPa (72 psi) to about 20 MPa (2,900 psi). The drive motor is in operable connection with the timing belt as shown. The lead screw 529 is in operable communication with the timing belt 525 and the lead screw 529 is rotated using the timing belt and drive motor 518. The drive motor 518 may be any suitable drive motor, but preferably is a stepper motor as described and exemplified above. An optional gear transmission may also be provided. In a preferred embodiment herein, the drive motor provides sufficient torque to overcome friction between the curable fluoropolymer composition within the ram device 521 while providing sufficient pressure to extrude the curable fluoropolymer composition material through the ram device 521 and out the outlet 540 of the printer nozzle.

The ram device 521 as shown further incorporates as shown a piston and barrel arrangement. The ram device 521 may further include a surround support structure which can act also as a heat sink or heat distribution source. As shown in the embodiment of FIGS. 15-19, the support structure is a standoff 590. The piston 531 is in connection with the load cell 561 which acts as a sensor for monitoring a load pressure on the ram device. The piston is movable upwardly and downwardly with the middle platen 580 which is a moveable platen that is capable of moving over the lead screw 529. As the piston is pulled upwardly and out of the barrel 541, curable fluoropolymer composition in the form of a feedstock may be introduced to the barrel. The piston 531 has an exterior surface 533. In one embodiment for reducing weight and cost and/or for controlling heat retention, the piston 531 may be hollowed so that it has an interior surface 593 which defines an interior space 535.

The barrel 537 has a first end 539 and a second end 541. The first end 539 of the barrel 537 is positioned at the upper end for receiving the piston 531 through a first opening 547 formed in the first end 539 of the barrel. When the piston is within the interior space of the barrel, the exterior surface of the piston faces the interior surface of the barrel. The two surfaces should be in facing engagement but with sufficient tolerance between them to enable slidable movement while preventing potential back extrusion between the surfaces during application of heat and pressure. The second end 541 of the barrel also preferably includes a second opening 549. The second end of the barrel is configured to be in communication with the printer nozzle 534. The barrel 537 has an exterior surface and an interior surface 543 that defines an interior space 545 within the barrel. The curable fluoropolymer polymer composition may be loaded into open barrel 537 before passing the piston into the barrel. The barrel is configured so that it receives the piston after passing it through the first opening 547 in the first end 539 of the barrel. The method herein as in embodiment 400, may include posing the piston by pressure into the interior space 545 of the barrel such that the exterior surface 533 faces the interior surface 543 of the barrel while applying pressure to the ram device. The curable fluoropolymer composition 510 of the system 500 may be preferably loaded into the barrel between the printer nozzle 534 and the first end 539 of the barrel 537.

For applying heat when and where desired in the method 400 herein, the apparatus 514 in the system may include or be in communication with a heating device 523, which may be a heater such as a band or wrap heater, heating element, external heating or at heater in communication with the piston and/or barrel of the ram device for heating the curable fluoropolymer composition. Preferably, the heating device is capable of heating the curable fluoropolymer composition to a temperature that is at least about 20° C. and up to at least about 250° C. The device may be capable of heating the curable fluoropolymer composition to a temperature that is less than about 250° C., less than about 200° C. or less than about 160° C. Preferred temperatures for heating the curable fluoropolymer about 20° C. to about 250° C. or about 70° C. to about 250° C., or about 100° C. to about 250° C., or about 105° C. to about 200° C., or about 115° C. to about 160° C. As noted above, the polymer may be optionally pre-heated prior to loading or printing following the parameters noted above for controlling the degree of crosslinking. When applying heat to the ram device, heat may be applied in the manner as described with prior embodiments, wherein the composition is heated to a temperature that is sufficient to initiate flow of the curable fluoropolymer composition within the ram device and that is below a temperature at which significant curing of the curable fluoropolymer composition occurs. Further, the composition may be heated to a temperature that is below a temperature corresponding to a time, T2, associated with the curable fluoropolymer composition as determined using a test method of ASTM D2084 on a rubber process analyzer as described in earlier embodiments herein. The heating device 523 may be positioned on or about the ram device in various locations, such as around the barrel, around then nozzle or both, or may be provided so as to heat the entire ram device. In one embodiment it is positioned on a heated portion 596 of the nozzle.

The curable fluoropolymer composition is preferably heated to a temperature which is below a temperature at which significant curing occurs. Examples of preferred temperatures are provided above and also with respect to embodiment 200, 200′.

With respect to the curable fluoropolymer composition 510, as with the compositions described above, it may be at least partially fluorinated or perfluorinated. For such polymers, and particularly for perfluoropolymers, the start of curing may be shown by thermal analysis using a differential scanning calorimeter (DSC).

In the ram device 521, the printer nozzle 534 is shown in an enlarged form in FIG. 19. The printer nozzle has a nozzle body 565, and a nozzle tip 567. Further, the printer nozzle 534 has a printer nozzle inlet 542 and a printer nozzle outlet 540. As shown, these are separate pieces that are connected together for operation and cleaning. However, it should be understood that such parts may be unitary as well.

As shown in FIG. 19, the printer nozzle 534 may be removably attached to the barrel 537, such as, e.g., by use of screw threads 551 on a portion of the interior surface 543 of the barrel of interior space 545 the barrel near its second end 541. Removable attachment facilitates cleaning and ease of change out of printer nozzles for different types of printer nozzles. An optional end cap 591 may also be provided for securing the ram device within the ram material extruder. The nozzle body 565 is configured so that it allows for smooth internal transition of the curable fluoropolymer composition as it leaves the barrel 537 to move toward the printer nozzle outlet 540. The nozzle body may thus by provided with mating threads 553 provided on its exterior for engaging threads 551 on the interior surface 543 of the barrel 537. While screw threads are employed in this embodiment, other connection devices or methods may be used, such as snap fit connectors, adhesives, press-fit connectors, screws or rivets, and, while not preferred in the embodiment shown, the nozzle may be made unitary with the barrel.

As shown and to facilitate flow, the nozzle body 565 has a tapered interior chamber 569 defined by the nozzle body as formed with an inlet 571 to receive the extruded composition extruded through the ram device 521 as it is pushed by the piston 531 through the barrel 537 and an outlet 572 in communication with the nozzle tip 567. The tapering as shown provides an inverted frustoconical configuration for good flow properties, but the chamber may be formed to be non-tapered, or have sloping without using a decreasing diameter round cross-sectional configuration as shown. Further, the chamber may be made to reduce in diameter or width as measured transversely across the nozzle body towards the nozzle tip in a stepped-like manner or in sections.

The nozzle body outlet 572 is positioned at a point where the nozzle tip 567 meets the nozzle body 565. The nozzle body 565 and nozzle tip 567 may be removably attachable in a preferred embodiment as shown for allowing interchange of different types of nozzle tips for different size extrudate or for different printing effects as well as for ease of cleaning, however, the entire printer nozzle may be formed such that the nozzle body and nozzle tip are a unitary piece. To assemble the detachable nozzle body 565 and nozzle tip 567 as shown, mating screw threads 594 are provided to the nozzle tip exterior that fits within the receiving opening of the nozzle body 565. At the point where the top of the nozzle tip 567 meets the outlet 572 of the nozzle body 565, a preferably a contiguous and continuous path is formed transitioning from the narrowest portion of the nozzle body chamber 569 at the nozzle body outlet 572 to a passage 575 within the nozzle tip 567 extending from an inlet 573 of the nozzle tip to the printer nozzle outlet 540. The passage is defined by the interior surface 574 extending from the inlet 573 of the nozzle tip to the printer nozzle outlet 540. As the passage approaches the printer nozzle exit 540 on the nozzle tip 567, a reduced diameter area 576 is preferably provided in a nozzle outlet end 595 for directing the extruded curable fluoropolymer composition through the printer nozzle outlet 540 as it is heated under application of pressure to passes through the printer nozzle outlet 540. In the method herein, printing the extruded curable fluoropolymer composition by application of pressure and heat extrudes the curable fluoropolymer composition through the inlet 571 of the nozzle body 565, the outlet 572 of the nozzle body 565, the inlet 573 of the nozzle tip 567 and the outlet 540 of the printer nozzle which is the outlet also of the nozzle tip.

The printer nozzle 534 may be configured in various sizes and shapes for printing. The opening of the nozzle tip 567 may be shaped as noted above for varying end effects and varying pressure as well as to take account of different viscosities of different curable fluoropolymer compositions as described in prior embodiments. For example, the printer nozzle may have a length measured longitudinally along the nozzle from the inlet of the nozzle body to the printer nozzle outlet 540 that is about one to about five times the inner diameter (ID) of the printer nozzle outlet 540, and preferably about 2 times the ID of the outlet 540. The ID of the printer nozzle outlet 540 as measured transversely across the opening preferably is preferably sized to be approximately the same size as a longitudinal cross sectional outer diameter of a seal or other article to be formed. Preferably it is at least about 0.2 mm and may be from about 0.2 to about 3.3 mm. In another embodiment, it may be about to about 0.4 to about 1.6 mm, or about 0.8 mm. Such measurements may vary according to desired nozzle end effects. Further, the printer nozzle 534 may be fitted with an external heating device 523 which optionally may be a heated exterior cuff or sleeve on the nozzle and/or barrel portions of the ram device 521. The efficiency in operation of the ram device allows for a wide variety of nozzle tip and nozzle length configurations, which may be adjusted based on operating pressure, temperature and the flow characteristics such as the viscosity of the curable fluoropolymer composition provided.

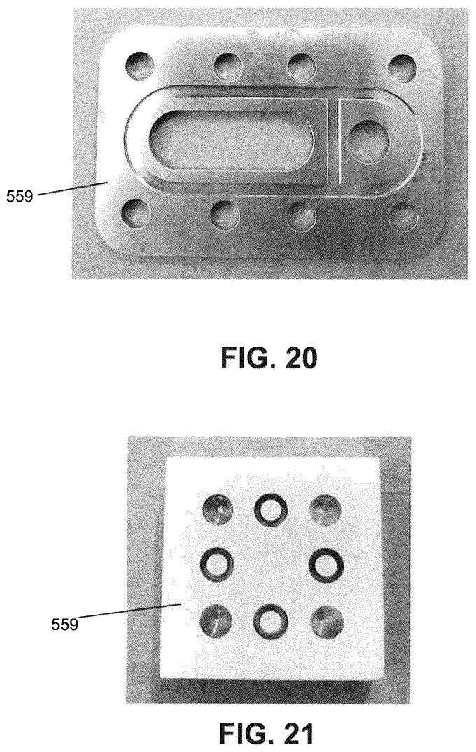

As the extruded fluoropolymer composition exits the nozzle tip, it is printed on a substrate 536. As with prior embodiments herein, the substrate 536 may be provided with a frictional surface 566, roughened or pre-coated with an adhesive or other treatment. The substrate may be a part or component onto which the extruded composition will be applied over the surface in a pattern or in a particular zone or area. For example, the substrate may be a base plate 559 for a seal 555 or gasket 557. If the substrate is a mold component, it may, for example, be printed on an upper surface of an upper mold plate surface and/or on an upper surface of a lower mold plate, wherein such upper surfaces may define a cavity for forming such molded articles. The extruded fluoropolymer composition may be printed within the cavity in such upper surfaces of the upper and/or the lower mold plates which cavity(ies) can be configured to receive the printed curable fluoropolymer extrudate in the shape of the article to be formed as a preform. In one preferred embodiment herein, the substrate may, e.g., be a mold base plate for a seal 555 or gasket 557, and the base plate may be in the form of a pre-sized mold for a seal or gasket (either an upper or lower mold plate) having a cavity defined therein for receiving the extruded printed material to fill the cavity as a preform. The preform printed part in the mold plate may be post-cured or otherwise more easily handled and/or the base plates may be assembled with the printed article situated between the plates and the plates or assembly may then be subjected to curing and/or post-curing. Mold base plates having cavities on a surface thereof with and without molded seals as parts are shown in FIGS. 20 to 23B.

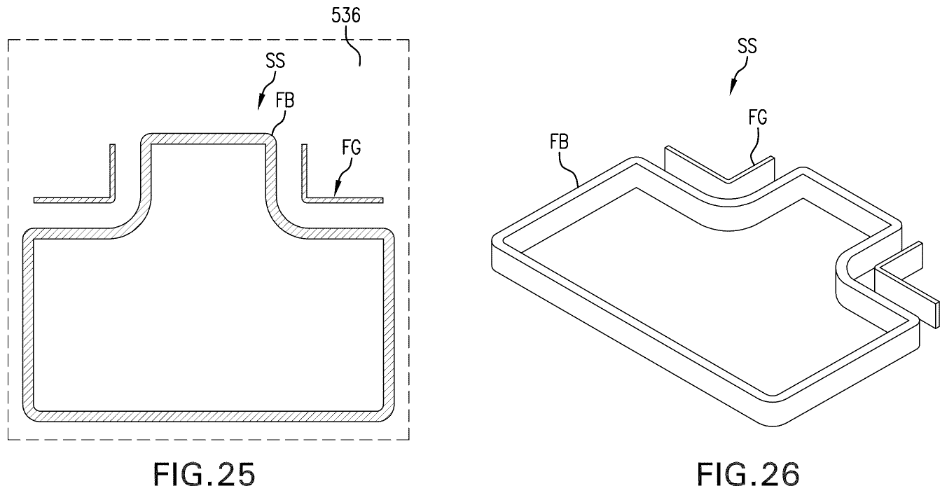

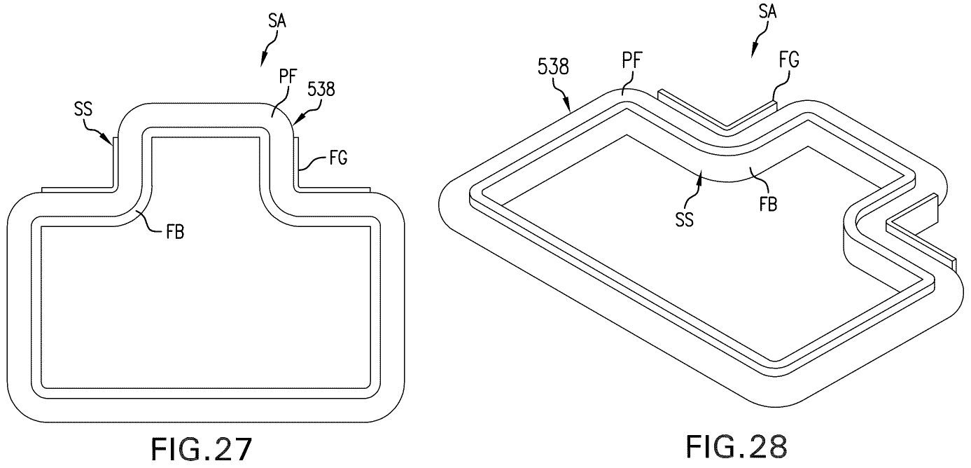

In other embodiments herein, the base plate may further include use of a support structure SS as shown in an example in FIGS. 25 and 26. The support structure may be positioned on a base plate 536 or other substrate to assist in shape retention of an extruded curable fluoropolymer as shown in one example of a support/preform assembly SA in FIGS. 26 and 27. As shown in FIGS. 25 and 26, the support structure includes two elements, a shaping frame in the form of a frame body FB and optional guide pieces FG. The pieces as shown are for forming a particular shape. The main support structure body and any related guide pieces may be altered in shape and size and any optional guide pieces moved to be internal or external to the frame body. The frame guide pieces FG shown are to assist in allowing shape retention around curved or arcuate areas. The frame body FB allows supports the general shape of the extruded article layer(s) upon printing and prior to any curing and/or post-curing steps to help assist in shape retention and reduce potential shrinkage after printing and curing and/or post-curing steps. The support structure SS is shown with a printed article 538 in the form of a sample preform PF in an support structure/preform assembly SA in FIGS. 26 and 27. As shown the preform PF lies between the frame guide pieces FG and the frame body FB of the support structure SS. The method herein may thus further include printing from the extrusion nozzle outlets as described above the extruded curable fluoropolymer(s) and/or perfluoropolymer(s) in the compositions herein in their uncured, or partially cured state using such a support structure. It will be understood that support structures can be varied in shape depending on the intended shape of the printed article. Support structures herein assist in improving quality of additive manufacturing printed seals formed according to the inventions herein by preventing the curable fluorine-containing polymers from shrking after deposition from the nozzle of the various additive printing mechanisms described in the embodiments herein.

The support structures herein may include a variety of materials such as thermoplastic material, metals and/or metal alloys. They may incorporate one or more such types of materials, e.g., a support structure may be made to include a thermoplastic material in one part of the structure, with a metallic layer or frame around that piece or with a different material used, for example, as a frame guide piece. If using printable thermoplastic materials, the support structures themselves may also be formed using additive manufacturing techniques or may be pre-molded shapes designed to act as support structures for the method herein. The preferred material for use in making support structures for use in the inventions hereof, include those that are able to withstand the intended curing temperature of the fluorine-containing elastomer, i.e., it should have a heat deflection temperature that is greater than the curing temperature of the elastomer to be printed. In the FKM/FFKM printing methods and apparatus herein, it is thus preferred that the support structures may withstand temperatures of at least about 130° C., at least 150° C. or at least 165° C. and sometimes even higher temperatures depending upon the curable fluorine-containing polymer chosen, its curing process and designated processing, curing and post-curing temperatures.

For example, for FKM/FFKM materials and compounds that cure at about 130° C., supports may be made using thermoplastics such as polycarbonates (e.g., 3DXMAX® polycarbonate having a 135° C. deflection temperature), polyvinylidene fluoride (e.g., FluorX™ PVDF having a deflection temperature of 158° C.), polyetherimide (e.g., ThermaX™ PEI having a deflection temperature of 160° C., high-temperature polylactic acid (e.g. Protopasta™ HTPLA having a deflection temperature of 150° C.), polyetheretherketone (e.g., 3D4Makers™ PEEK having a deflection temperature of 156° C.), polyphenylsulfone (e.g., ThermaX™ PPSU 3D, having a deflection temperature of 190° C. or other suitable materials. For higher curing temperature FKM/FFKMs having a cure temperature of about 150° C., the FluorX™ PVDF, ThermaX™ PEI, 3d4Makers™ PEEK or ThermaX™ PPSU 3D materials or other suitable materials may be used. At cure temperatures above 165° C., the ThermaX™ PPSU 3D or other suitable materials may be used. For FKM/FFKM cure temperatures of about 160° C. and over, metals and metal alloys with melting points above 160° C. may also be used as permanent support structures, including, e.g., aluminum, stainless steel, brass and the like.

Support structures are preferably removable from the substrate such as from a base plate, but may be formed as part of a substrate, base plate or in addition to a base plate.

As the extruded composition leaves the nozzle tip, forming the fluorine-containing elastomer article 538 it may be initially at least partially cured, such that further curing may be carried out, as noted in prior embodiments, with post-curing or additional heating after removal of the article from the substrate or on a base plate such as an upper and/or a lower mold base plate which may be assembled to form a mold, which may be cured, e.g., in an oven or similar heating device. The curable fluoropolymer composition may be selected such that it is sufficiently tacky so that it may self-adhere to the substrate 536 but still be able to be removable from the substrate while substantially retaining its structural integrity. While processing the fluoropolymer composition through the ram device, the fluoropolymer composition may be processed without curing or if at least partially cured provided it is still processible and flexible for printing, for example, by evaluating polymer viscosity and rheological properties so as to maintain the temperature below that of the temperature corresponding to a time, T2, associated with the curable fluoropolymer composition as determined using a test method of ASTM D2084 on a rubber process analyzer as described elsewhere herein. The degree of cure that is acceptable during printing will thus depend somewhat on the specific curable fluoropolymer composition and curable fluoropolymer(s) chosen. In certain embodiments, and taking into account the foregoing, it may be cured to a degree greater than 0% but preferably less than about 25% during printing.

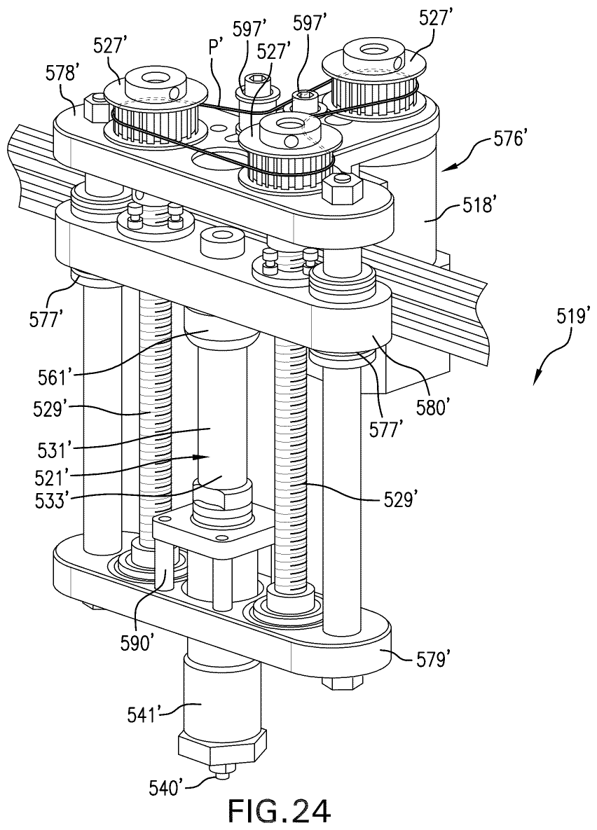

In a further embodiment herein, a variation of the ram material extruder 519 described above in embodiment 500 is shown in FIG. 24 as ram material extruder 519′. In all common respects and in its use in printing, the parts are analogous and all parts have analogous reference numbers unless otherwise indicated. The devices 519, 519′ differ with respect to the location of the timing belt wheels and timing belt placement area as well as the number of lead screws used. The device 519′ is available from the sources noted above or can be built thereby under the identifier, ARME 2. The device 519′ includes a lower platen 579′ that supports the operable apparatus of the extruder 519′. In the embodiment shown, the drive mechanism 516′ may include a drive motor 518′ and a timing belt of the type shown in FIG. 15 as belt 525. The belt is not shown in FIG. 24, but the same type of belt as 545 would be made larger and routed along the path shown by curved line P′ operable on three timing belt wheels 527′ and using a tensioners or similar drive pin such as pins 597′. Further, more wheels than three may be used if desired or one or more gear mechanisms could be employed. However, in the apparatus embodiment 519′ shown, the drive mechanism 516′ incorporates a timing belt such as belt 525 and three wheels 527′ as shown, one associated with the drive motor 518′ and one associated with each primary or lead screw 529′. Two lead screws 529′ are incorporated in this embodiment. The drive mechanism 516′ may be used in the method herein and operated to apply pressure to the ram device 521′.

The drive mechanism motor 518′ operates a timing belt which moves along path P′ and rotates the wheels 527′ in communication with lead screws 529′ which are shown passing through the lower platen 579′ and extending upward through the ram material extruder 519′ passing through an opening in a middle platen 580′ and terminating in an upper platen 578′. The middle platen is movable in the z-direction (generally longitudinally) up and down so as to apply pressure to the ram device 521′. As the lead screws 529′ are rotated by the drive mechanism and timing belt movement, the nuts 577′ facilitate rotation and supports the lead screws, allowing the middle platen 580′ to move upwardly or downwardly. When the middle platen 580′ moves downwardly it depresses the top of the ram device 521′ at the load cell 561 in contact with a piston 531′ as above. As shown in FIGS. 15 and 24, it can be seen that the upper platens 578, 578′ are of a different configuration with the upper platen 578′ being larger to allow for mounting on a rear portion of the upper platen 578′ the printer drive mechanism 516′. In FIG. 15, the drive mechanism 516 is mounted on the lower platen 579 and so the lower platen 579 is enlarged in device 519 to accommodate the drive mechanism 516.

With use of ram material extruder 519′, the method may include operating the drive mechanism 516′ to apply pressure to the ram device. Suitable pressure to be applied to the ram device can range from about 0.5 MPa (72 psi) to about 20.7 MPa (3,000 psi) with this device which is higher than ram material extruder 519 to allow for increased pressure and accommodate high volume extrusion. The drive motor 518′ is in operable connection with a timing belt in the same manner as the motor operates with the timing belt in ram material extruder 519 but along path P′. The lead screws 529′ are in operable communication with a timing belt and the rotation of the lead screws 529′ rotated by a timing belt and the drive motor 518′ drive the platens and actuate the piston. The drive motor 518′ may be any suitable drive motor, but with ram material extruder 519, the drive motor is also preferably a stepper motor as described and exemplified above. An optional gear transmission may also be provided also as described above with respect to previous embodiments. The drive motor 518′ also provides sufficient torque to overcome friction between the curable fluoropolymer composition within the ram device 521′ while providing sufficient pressure to extrude the curable fluoropolymer composition material through the ram device 521′ and out the outlet 540′ of the printer nozzle.

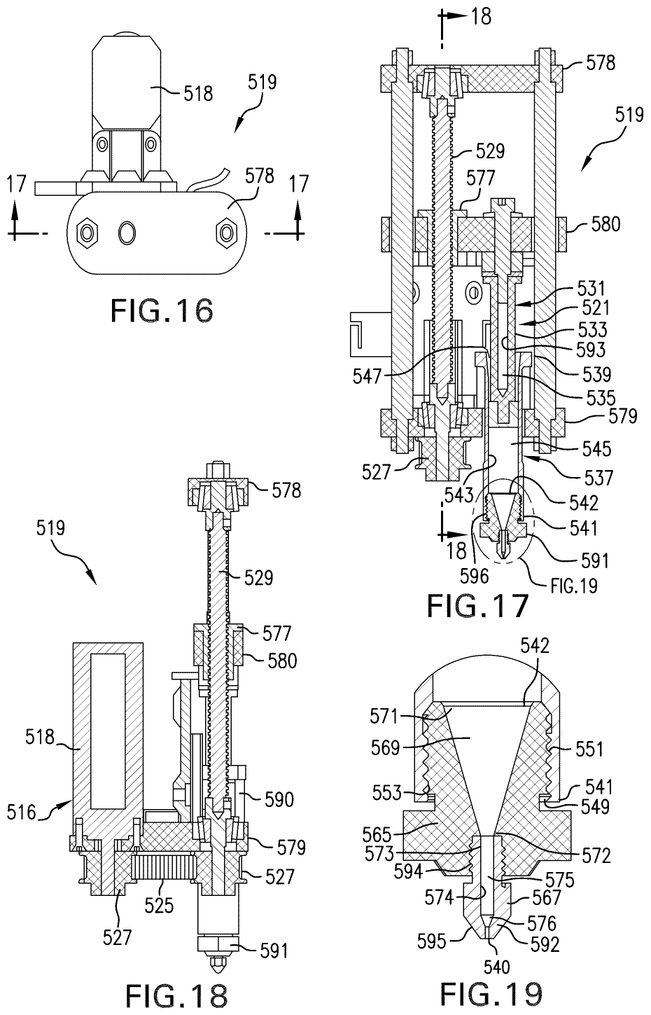

The ram device 521′ as shown further incorporates as shown a piston and barrel arrangement which is the same as that of ram device 521, and may further include a surround support structure which can act also as a heat sink or heat distribution source in the same manner. The support structure is a standoff 590′ similar to that of ram material extruder 519. The piston 531′ is in connection with the load cell 561′ which acts as a sensor for monitoring a load pressure on the ram device. The piston is movable upwardly and downwardly with the middle platen 580′ which is a moveable platen that is capable of moving over the lead screws 529′. As the piston is pulled upwardly and out of the barrel 541′, curable fluoropolymer composition in the form of a feedstock may be introduced to the barrel. The piston 531′ has an exterior surface 533′. In one embodiment for reducing weight and cost and/or for controlling heat retention, the piston 531′ may be hollowed and configured in the same manner as shown for piston 531 in FIGS. 16-19 associated with ram material extruder 519. In all other ways, operation of the nozzle, piston and barrel are the same in ram material extruders 519, 519′, and the primary differences are the location of the drive mechanism 516′ in ram material extruder 519′, and its use of two lead screws 529′ and three wheels 527′ to create a different timing belt path P′ using pins 597′ and wheels 527′, allowing for additional extruder pressure on the piston.

The invention will now be described with respect to the following non-limiting examples.

### EXAMPLE 1

Three curable fluoropolymers were evaluated for additive manufacturing using an apparatus as shown in FIG. 2 herein. The first curable fluoropolymer compound of an FKM commercially available as Tecnoflon® 959 from Solvay (Sample 1). The second compound included an FFKM available from Greene, Tweed of Kulpsville, PA as Chemraz® G20 (Sample 2). The third compound included an FKM based on Tecnoflon® VPL 75545 (Sample 3).

The FFKM in Sample 2 included a curable perfluoropolymer and a bisphenyl-based curative which was added at 1.3 parts by weight to the base perfluoropolymer. No additional additives were incorporated in the composition.

The FKM in Sample 1 was blended with a peroxide cure system making up 5 parts by weight per hundred parts of the FKM polymer, silica filler was incorporated in 13 parts by weight per hundred parts of the FKM polymer, and a colorant and processing aid were further included. The Sample 2 FFKM and the Sample 1 FKM compounded materials were selected based on the rigidity associated with the compounded FFKM and the tackier nature of the FKM compound, as well as the respective glass transition temperatures, filament extrusion capability and moving die rheology (MDR) properties of the materials. The third Sample FKM included a carbon black filler as well as 2 parts by weight per hundred parts of the polymer of a peroxide curative and 3 parts per hundred parts by weight of the polymer of co-curative. This compound was also chosen for tackiness and a varied curing and thermal analysis curve in comparison to the other samples.

Filaments were extruded in two outer diameter sizes, 1.7 mm and 2.7 mm. Experimental trials were conducted both with and without the curative to assess the performance and properties of the materials as filaments. The DSC profiles were run, and are shown, respectively for Samples 1, 2, and 3 in FIGS. 8, 9 and 10 to provide the best ranges and guidelines for printing the materials of the Samples.

The materials were introduced for printing into both an Ultimaker and a Monoprice Maker Select Plus. The latter was most suitable for printing the materials and used for further trials.

The apparatus included an upwardly and downwardly extending support tube formed of PTFE for supporting the extruded filament. A side hole was provided to the tube as described above. The step motor was modified by a geared transmission including a series of planetary gears as shown in FIG. 7A, and the nozzle opening was 2 mm. The temperature in the apparatus was kept at 115° C. for printing, and the acceptable range for printing the FKM and FFKM (which is about 90° C. to about 120° C.).

The print head was set for a layer height of 1 mm, a line width of 1.75 mm, an infill density of 100%, a printing temperature of 200° C., a build plate temperature of 25° C. and a print speed of 4 mm/s. This layer height and line width were increased from standard print levels to coincide with the increased nozzle width.

The temperature was maximized to lower the viscosity sufficiently for an easier extrusion from the nozzle and to encourage adhesion to a frictional surface formed of an adhesive tape material positioned on the substrate surface. Tensile bars according to ASTM D412-C were successfully printed from the materials.

### EXAMPLE 2

A compound was prepared based on the perfluoropolymer sold as Tecnoflon® LT, which was a semi-tacky elastomer material. The compound (Sample 4), included a curable perfluoropolymer and a bisphenyl-based curative which was added at 1.3 parts by weight to the base perfluoropolymer. No additional additives were incorporated in the composition was printed using a printing apparatus as shown in FIGS. 11 and 11A having a pre-cooler mounted on a moveable Hemera® extruder as a drive mechanism therein. Samples were run using a nozzle opening at 1.5 mm and a nozzle temperature of 80° C.

Prior to printing, DMA analysis data was collected on both Sample 4 and Sample 3 (used in Example 1). Regarding Sample 4, DMA analysis was run at low temperatures from −80° C. to 20° C. at a heating rate of 3° C./min and at a 50 gm force/load. Cooling was achieved using liquid nitrogen. A compound sample was prepared as an O-ring with a 139 in./diameter ratio using an uncured material. The DMA analysis was a tension DMA. The high temperature DMA analysis was collected for the samples at temperatures from 25° C. to 150° C. at the same heating rate with both a 500 gm force/load and a 50 gm force/load, and the same compound sample dimension, but with a compression DMA analysis. The same tests were run with Sample 3 but only at 50 gm force/load. This data was used to select a printing temperature and to estimate storage modulus, G′, in Pa. The estimate graph shown for Sample 4 appears in FIG. 12.

The estimated storage moduli were used as elastic moduli for estimating the maximum buckling force, maximum printing pressure and maximum draw-down ratio. The estimated moduli and calculated buckling force F_{cr}, as well as the calculated maximum pressure (MPa), Maximum draw ratio are shown below in Table 2. Based on this data, a minimum nozzle diameter (mm) was determined for the apparatus employed.

TABLE 2

| | Cold Semi- | Warm Semi- | Cold | Warm |
|---|---|---|---|---|
| | Tacky | Tacky | Sticky | Sticky |
| | Sample 4 | Sample 4 | Sample 3 | Sample 3 |
| Estimated Storage | 1370 | 80 | 50 | 2 |
| Modulus (MPa) | | | | |
| Buckling Force (N) | 389 | 22.8 | 9.1 | 0.36 |
| Maximum Pressure | 162 | 9.4 | 2.8 | 0.15 |
| (MPa) | | | | |
| Max Draw Ratio | 0.64 | 1.65 | 0.68 | 1.69 |
| (B = A₀A_{f}) | | | | |

From this data, samples were printed into test plates on metal in the form of seals using filaments of a 1.75 mm diameter and a free column length of 0.005 m using the apparatus of FIGS. 11 and 11A.

### EXAMPLE 3

In this example, an additive printing of an electrostatic chuck (ESC) seal and a bonded gasket as three-dimensional additively manufactured articles were prepared using an additive manufacturing printer apparatus having an additive ram material extruder (ARME).

The additive manufacturing printer apparatus included a Creality3D Ender-5 Pro 3D Printer and controller and a ram material extruder which was mounted on the printer. The ram material extruder is according to the drawings shown in FIGS. 13-19 herein. The printer apparatus was turned on and the load cell indicator was plugged into a standard power source in a wall electric outlet. The load cell sensor/indicator was calibrated upon turning the apparatus on as is done with each use in accordance with the manufacturing instructions for the ram material extruder. About 10-15 grams of a curable fluoropolymer composition including which was either partially fluorinated or perfluorinated in compounded gum form, as described below, was cut into pieces of about one cubic centimeter or smaller, which pieces were loaded into the barrel of the ram device on the ram material extruder. The additive manufacturing printer was interfaced to a control software on a computer in communication with the printer and a controller. The computer provides a process plan with a series of commands and has a processor and software for additive printing. The computer may be of the built in-type or a separate computer connected to the printer by USB, HDMI or other similar connections. On the particular printer used, the computer includes open-source Pronterface software, and particularly included the Pronterface Printrun software, although in accordance with the invention, any acceptable three-dimensional printing software that works with a ram material extruder and additive manufacturing printing apparatus may be used. Pronterface provides a graphical user interface to allows monitoring and control of the additive manufacturing printer apparatus with connection to the printer. The software can be configured to operate a controller or as a controller to operate the drive mechanism, including its motor, and to control the heating device for adjusting its temperature. It is also capable of sending the G-code commands directly by way of a terminal, console window or other typical G-code operation.

After loading the curable fluoropolymer composition into the ram material extruder, the printer was instructed by the computer to actuate and to send a cold extrusion command “M302P1” using the control software, the printer was commanded to extrude until a load of 100 lbs. was shown on the calibrated load cell indicator. The cold extrusion step allows for priming of the curable fluoropolymer composition for going through a preprinting step. Once the curable fluoropolymer composition was primed in the barrel, a G-code for the printing of the wolf gasket and seal made in this Example was loaded for operation using the control software, although it could also be loaded on the additive manufacturing printing apparatus' SD card. The printing G-code of the desired seal was prepared using a MATLAB script to modify the printing parameters and settings. Directions for using the MATLAB code are provided below. If no modification is needed when making different article, the provided G-code can be loaded directly to operate with the printer's control software or by using the printer's SD card which is inserted into the printer direct control. The wolf gasket seal's base plate was placed onto the printing platform of the Creality3D Ender-5 Pro 3D Printer in a location consistent with the selected G-code and/or with coordinates chosen in the MATLAB script.

The printer was directed to print a dry run without application of heat from a heating device so that the printer was able to go through the associated movements required by the seal's printing g-code and locate the seal's base plate which was used as the printing substrate. Location of the base plate in the dry run allows for accurate printing. When the base plate was in place, it was coated with a thin layer of Elmer's® spray adhesive to promote adhesion of the printed material onto the base plate. After the dry run, a heating band was used as a heating device and was connected to a power source, turned on and set to the desired printing temperature for the curable fluoropolymer composition chosen.

Based on applicant's testing it was determined that operation of the ram material extruder worked based at a temperature of less than 200° C. and preferably at about 100° C. for printing compositions incorporating partially fluorinated curable fluoropolymers (FKMs). Printing for the FKMs at 100° C. allowed for a print time of about 60 to about 70 minutes.

Compositions including perfluorinated curable fluoropolymers (FFKMs) were preferably printed also at less than 200° C. and preferable at a temperature of 140° C., which allowed for about 15 minutes of print time prior to initiation of curing which would make printing difficult to complete.

When the desired printing temperature was reached from use of the heating device, the operation was held another 5 minutes to allow the temperature to stabilize throughout the loaded curable fluoropolymer composition and throughout the barrel. The printer was then instructed to extrude material until sufficient pressure was reached in the barrel as indicated by the load cell indicator. The pressure range used in the print trials was about 300-400 lbs. After about 300 pounds pressure was achieved within the barrel, the operator instructed the printer to activate a printing cycle based on the loaded G-code.

The MATLAB directions for modifying the seal printing G-code used were as follows:

Open in MATLAB “DoubleLayer_WolfGasket.m” for a bonded gasket (in this case a wolf gasket) or “FourPoint_Seal.m” for printing a seal. These scripts were prepared to produce G-code for the printer to print the respective seals and gaskets.

The scripts included labeled parameters to adjust the printing speed and printing height of the extruded curable fluoropolymer composition during printing according to the desired print parameters.

Depending on the material being printed, the Extrusion multiplier, a parameter in the MATLAB script which controls the flow rate of the printing process based on the compound used, is adjusted for optimal results.
a 30× adjustment may be used for FFKM compounds and
a 20× adjustment may be used for the FKM compound.

The printer software and the G-code were also programmed to have the desired printing starting location. This determines where the seal plate will be placed on the printer platform for accurate printing.

While inputting desired printing parameters, the name of the resulting output G-code file can be changed to a desired name for later use.

Once the script was run and the G-code for the printer was completed to have the desired parameters, including the printed seal's starting position which was given as the input to the script, the seal plate was placed into its designated position consistent with the starting point parameter(s).

After the seal was positioned, the seal plate was coated with the spray adhesive noted above to promote adhesion between the deposited material and seal plate.

The resulting seals printed are shown in FIGS. 20-23B.

The curable fluoropolymer composition used for printing a bonded gasket and a seal are provided in the Table 3 below where the components are expressed in parts per hundred based on 100 parts by weight of the curable fluoropolymer in the composition. The FKM composition was prepared in two different compositions: Sample A and Sample B, each of which included Tecnoflon® VPL75545 FKM fluoropolymer that is publicly available from Solvay® as a peroxide curable polymer. Diak 7 triallyl isocyanurate co-curative was used with a Varox® DBPH peroxide curative or a Varox® 130XL peroxide curative. The Sample A and B compositions also included silica filler and addition of a low molecular weight polytetrafluoroethylene (PTFE) lubricating filler from Daikin Industries, available commercially as Polyflon®. A further Sample C was formed using a curable fluoropolymer available from Greene, Tweed® of Kulpsville, PA, that was perfluorinated (perfluoropolymer), i.e., Tecnoflon® PFR X1055D (which uses the polymer of Tecnoflon® PFR X1055B, but includes N990 carbon black) and a bisaminophenol (BOAP) curative.

TABLE 3

| Component | FKM Sample A | FKM Sample B | FFKM Sample C |
|---|---|---|---|
| Tecnoflon FKM | 100 | 100 | — |
| Tecnoflon FFKM | — | — | 100 |
| PTFE L-5F | 30 | 30 | — |
| Aerosil® R072 | 5 | 5 | — |
| N990 Carbon Black | — | — | 25 |
| Diak 7 | 3 | 3 | — |
| Varox® DBPH | 1 | — | — |
| Varox® 130XL | — | 2 | — |
| BOAP | — | — | 1.65 |

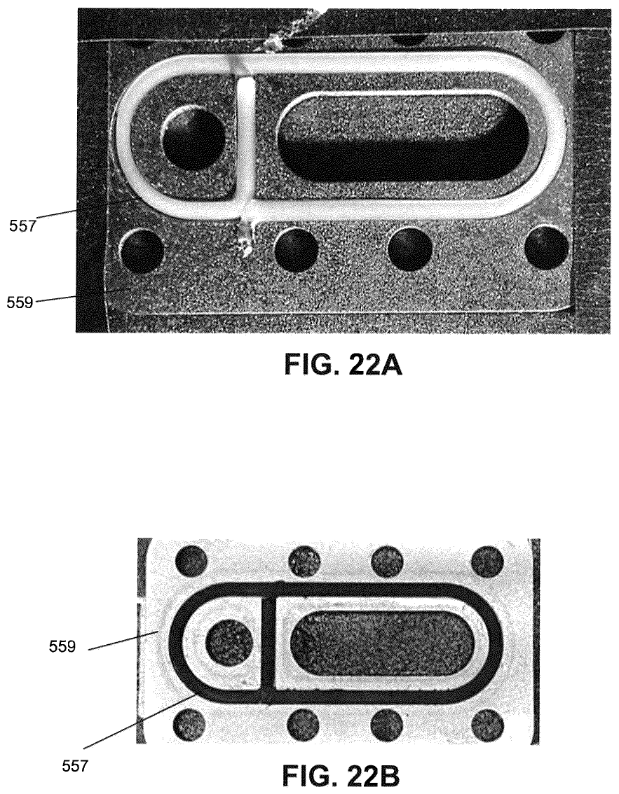

Sample A was extruded at a printing speed of 0.75 mm/s using a nozzle outlet diameter of 0.8 mm, and heating the ram device to a barrel temperature of 100° C. The substrate for printing was a base plate of a wolf gasket for three-dimensional printing as in FIG. 20 treated with Elmer's® Spray Glue. The resulting printed bonded gasket (wolf gasket) is shown in FIG. 22A. Sample C was extruded at a printing speed of 1 mm/s using a nozzle outlet diameter of 1.4 mm. The ram device was heated to have a barrel temperature of 140° C. The same base plate as shown in FIG. 20 was used and treated with Elmer's® Spray Glue. The resulting three-dimensionally printed wolf gasket is shown in FIG. 22B

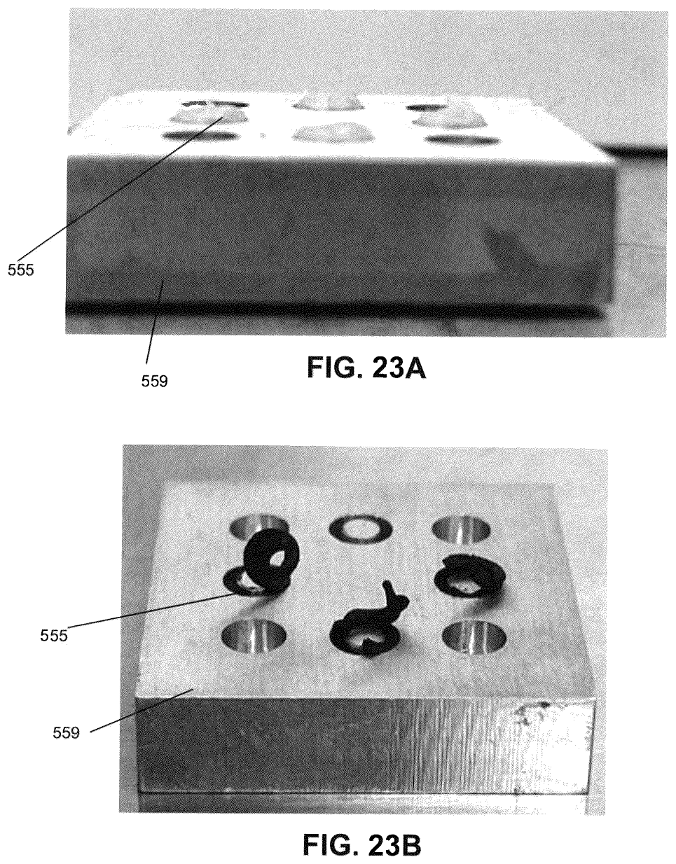

An ESC seal was printed using a base plate as in FIG. 21 as a receiving substrate for printing the seals. The base plate was treated with Elmer's Spray Glue for each seal printed. A three-dimensionally printed ESC seal was printed using Sample A as shown in FIG. 23A. The seal was printed using a nozzle diameter of 0.8 mm, a barrel temperature of 100° C. and a printer speed of 1 mm/s. A further ESC seal using the same base plate as in FIG. 21 was printed using Sample C perfluoropolymer having a nozzle diameter of 1.4 mm, a barrel temperature of 140° C. and a printer speed of 1 mm/s. The resulting seal is shown in FIG. 23B.

The Example herein demonstrated that the system herein of use of curable fluoropolymer compositions with an additive manufacturing printing apparatus can be incorporated into a method using the system having a ram material extruder to improve reproducibility of parts successfully formed with good accuracy. The parts made are those with complex shapes and the ability to make such parts reproducibly will reduce manufacturing costs by reduction in waste and provide the ability to make specialty parts and/or parts that are difficult to produce through compression molding.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-50. (canceled)

51. A system for forming three-dimensional, additively manufactured fluorine-containing elastomer articles, comprising:
(i) a curable fluoropolymer composition; and
(ii) an additive manufacturing printer apparatus capable of forming a three-dimensional printed article, the apparatus comprising:
a programmable additive manufacturing printer;
a ram material extruder comprising
a ram device operable for receiving the curable fluoropolymer composition and extruding the curable fluoropolymer composition under pressure,
a printer nozzle having an inlet and an outlet, and
a drive mechanism for applying pressure to the ram device, wherein the ram device is operated according to instructions from the programmable additive manufacturing printer; and
a heating device for applying heat to the ram device, including the printer nozzle thereof;
wherein the printer nozzle is configured to receive the curable fluoropolymer composition through the inlet of the printer nozzle under pressure and to allow for heated extrusion of the fluoropolymer composition through the printer nozzle outlet for printing a fluorine-containing elastomer article.

52. (canceled)

53. The system according to claim 53, wherein the drive mechanism comprises a drive motor in operable connection with a timing belt, and where the drive motor is a stepper motor having a geared transmission.

54. The system according to claim 53, wherein the ram material extruder further comprises at least one lead screw and a movable platen capable of moving over the at least one lead screw, wherein the at least one lead screw is in operable communication with the timing belt.

55. The system according to claim 54, wherein there are two lead screws.

56. The system according to claim 51, wherein the ram device comprises a piston having an exterior surface and a barrel having a first end, a second end and an interior surface that defines an interior space, wherein the barrel is configured to receive the piston after passing through a first opening in the first end of the barrel and wherein the second end of the barrel is located to be in communication with the printer nozzle, wherein when the piston is within the interior space of the barrel, the exterior surface of the piston faces the interior surface of the barrel.

57. (canceled)

58. The system according to claim 51, wherein the heating device is capable of heating the curable fluoropolymer composition to a temperature that is sufficient to initiate flow of the curable fluoropolymer composition within the ram device and that is below a temperature at which significant curing of the curable fluoropolymer composition occurs.

59. The system according to claim 51, wherein the heating device is capable of heating the curable fluoropolymer composition to a temperature that is below a temperature corresponding to a time, T2, associated with the curable fluoropolymer composition as determined using a test method of ASTM D2084 on a rubber process analyzer.

60. The system according to claim 51, wherein the additive manufacturing printer apparatus is capable of forming a three-dimensional printed article comprising a fluoroelastomer that is at least partially fluorinated.

61. The system according to claim 51, wherein the additive manufacturing printer apparatus is capable of forming a three-dimensional printed article comprising a perfluoroelastomer.

62. The system according to claim 51, wherein the additive manufacturing apparatus is capable of forming an article selected from a gasket and a seal.

63. The system according to claim 62, wherein the article is printed on a base plate and the article is a bonded gasket or a bonded seal.

64. The system according to claim 63, wherein the base plate is an upper mold base plate having an upper surface defining a cavity and/or a lower mold base plate having an upper surface defining a cavity, and the article is printed on at least one of the upper surface of the upper mold base plate within the cavity thereof and/or the upper surface of the lower mold base plate within the cavity thereof.

65. The system according to claim 63, wherein a support structure is positioned on the base plate for assisting in shape retention of the extruded curable fluoropolymer composition.

66. The system according to claim 65, wherein the support structure is a removable fixture and comprises one or more of thermoplastic material, metal, and metal alloy.

67. (canceled)

68. The system according to claim 65, wherein the support structure is made by additive manufacturing.

69. The system according to claim 51, wherein the ram device further comprises a load cell that acts as a sensor for monitoring pressure within the ram device.

70. The system according to claim 51, wherein the heating device is capable of heating the curable fluoropolymer composition to a temperature that is about 20° C. to about 250° C.

71. (canceled)

72. The system according to claim 70, wherein the heating device is capable of heating the curable fluoropolymer composition to a temperature that is about 100° C. to about 250° C.

73. (canceled)

74. The system according to claim 72, wherein the heating device is capable of heating the curable fluoropolymer composition to a temperature that is about 115° C. to about 160° C.

75. The system according to claim 51, wherein the heating device is positioned on the ram device.

76. The system according to claim 51, wherein the printer nozzle comprises a nozzle body and a nozzle tip, the nozzle body defines a tapered interior chamber having an inlet for receiving the curable fluoropolymer composition extruded through the ram device and an outlet in communication with an inlet to the nozzle tip, the nozzle tip has an interior surface extending from the inlet of the nozzle tip to the outlet of the printer nozzle.

77. The system according to claim 76, wherein the nozzle tip has a reduced diameter area at nozzle outlet end thereof for directing the extruded curable fluoropolymer composition through the outlet of the printer nozzle, and wherein an inner diameter of the printer nozzle outlet is about 0.2 mm to about 1.6 mm as measured transversely across the printer nozzle outlet.

78. (canceled)

79. The system according to claim 51, wherein the additive manufacturing printer apparatus is capable of printing at a temperature of at least about 20° C. and at a temperature less than about 250° C., less than about 200° C. or less than about 160° C.

80.-82. (canceled).
